(19) United States
(12) Patent Application Publication
(10) Pub. No.: US 2025/0066189 A1
(43) Pub. Date: Feb. 27, 2025

(54) SYSTEMS AND METHODS FOR ELECTRIC PROCESSING

(71) Applicant: Monolith Materials, Inc., Lincoln, NE (US)

(72) Inventors: Mathew LEIS, Lincoln, NE (US); Christoper J.-P. CARDINAL, Lincoln, NE (US); Enoch DAMES, Lincoln, NE (US); Shruthi DASAPPA, Lincoln, NE (US); Alexander HOERMANN, Lincoln, NE (US)

(21) Appl. No.: 18/628,630

(22) Filed: Apr. 5, 2024

Related U.S. Application Data
(63) Continuation of application No. PCT/US22/45451, filed on Sep. 30, 2022.
(60) Provisional application No. 63/253,996, filed on Oct. 8, 2021.
(60) Provisional application No. 63/298,912, filed on Jan. 12, 2022.
(60) Provisional application No. 63/350,801, filed on Jun. 9, 2022.
(60) Provisional application No. 63/375,024, filed on Sep. 8, 2022.

(51) Int. Cl. C01B 3/24; B01J 19/08; C01B 32/05

(52) U.S. Cl. CPC C01B 3/24; B01J 19/088; C01B 32/05; B01J 2219/00162; B01J 2219/0807; B01J 2219/0869; B01J 2219/0896; C01B 2203/0272; C01B 2203/0861; C01B 2203/1235

(57) ABSTRACT

Carbonaceous material and/or hydrogen may be generated using systems and methods provided herein.

### CROSS-REFERENCE

This application is a continuation of International Application No. PCT/US2022/045451, filed Sep. 30, 2022, which claims the benefit of U.S. Provisional Application Nos. 63/253,996, filed Oct. 8, 2021, 63/375,024, filed Sep. 8, 2022, 63/298,912, filed Jan. 12, 2022, and 63/350,801, filed Jun. 9, 2022, each of which is incorporated herein by reference in its entirety.

### BACKGROUND

Carbonaceous material and/or hydrogen may be produced by various chemical processes. Performance, energy supply and environmental performance associated with such chemical processes has evolved over time.

### SUMMARY

The present disclosure recognizes a need for more efficient and effective processes to produce, for example, carbonaceous material and/or hydrogen.

The present disclosure provides, for example, a method of processing, comprising producing hydrogen by heating a hydrocarbon with a plasma generator at a pressure greater than atmospheric pressure. The method may further comprise adding the hydrocarbon to the plasma generator. The plasma generator may comprise AC or DC electrodes. The method may further comprise producing carbonaceous material. The carbonaceous material may comprise carbon particles. The method may further comprise continuously producing the hydrogen and carbonaceous material. The hydrocarbon may be a gas, natural gas, or comprise natural gas. The method may further comprise heating the hydrocarbon and producing the hydrogen in a single chamber. The method may further comprise producing the hydrogen and carbonaceous material in a once-through, single stage process. The method take place at a pressure greater than equal to about 2 bar. The method take place at a pressure greater than equal to about 5 bar. The method take place at a pressure greater than equal to about 10 bar.

The present disclosure also provides, for example, a method of processing, comprising producing hydrogen in a substantially inert or substantially oxygen-free environment or atmosphere by heating a hydrocarbon with electrical energy at a pressure greater than atmospheric pressure. The method may further comprise producing carbonaceous material. The carbonaceous material may comprise carbon particles. The method may further comprise continuously producing the hydrogen and carbonaceous material. The hydrocarbon may be a gas, natural gas, or comprise natural gas. The method may further comprise directly heating the hydrocarbon with electrical energy. The hydrogen may be produced in a refractory-lined reactor. The method may further comprise heating the hydrocarbon and producing the hydrogen in a single chamber. The method may further comprise producing the hydrogen and the carbonaceous material in a once-through, single stage process. The method may further comprise using the electrical energy to remove the hydrogen from the hydrogen. The method take place at a pressure greater than equal to about 2 bar. The method take place at a pressure greater than equal to about 5 bar. The method take place at a pressure greater than equal to about 10 bar. The method may further comprise using a heat exchanger, a filter, and solid handling equipment. The solid handling equipment may include a cooled solid carbon collection screw conveyor, an air locking and purge system, a pneumatic conveying system, a mechanical conveying system, a classifying mill, and a product storage vessel. The method may further comprise producing the hydrogen in a substantially oxygen-free environment or atmosphere. The method may further comprise producing the hydrogen in a substantially inert environment or atmosphere.

The present disclosure also provides, for example, a method of producing hydrogen in a substantially inert or substantially oxygen-free environment or atmosphere by directly heating a hydrocarbon with electrical energy. The hydrocarbon may be a gas, natural gas, or comprise natural gas. The method may further comprise producing carbonaceous material. The carbonaceous material may comprise carbon particles. The method may further comprise continuously producing the hydrogen and carbonaceous material. The method may further comprise generating a plasma. The plasma may be generated using AC electrodes. The plasma may be generated using DC electrodes. The method may further comprise producing the hydrogen in an environment or atmosphere comprising less than about 2% molecular oxygen by volume or mole. The method may further comprise heating the hydrocarbon and producing the hydrogen in a single chamber. The method may further comprise producing the hydrogen and the carbonaceous material in a once-through, single stage process.

In another aspect, the present disclosure provides a method of producing carbon particles in a reactor, comprising (a) using one or more electrodes to generate a plasma in the reactor; and (b) injecting, through one or more injectors, a hydrocarbon into the reactor such that the hydrocarbon contacts the plasma, thereby producing the carbon particles, wherein the reactor is operated at a pressure greater than or equal to about 1.5 bar.

In some embodiments, the one or more electrodes comprise AC electrodes. In some embodiments, the one or more electrodes comprise DC electrodes. In some embodiments, the method further comprises producing hydrogen. In some embodiments, the method further comprises continuously producing the hydrogen and the carbon particles. In some embodiments, the method further comprises producing the hydrogen and the carbon particles in a once-through, single stage process. In some embodiments, the hydrocarbon is a gas. In some embodiments, the hydrocarbon comprises natural gas. In some embodiments, the hydrocarbon is heated upon contact with the plasma. In some embodiments, the carbon particles have a smaller surface area than carbon particles formed in the reactor when operated at a pressure of less than about 1.5 bar. In some embodiments, the carbon particles have about 90% of the surface area as compared to carbon particles formed in the reactor when operated at a pressure of about 1 bar. In some embodiments, the reactor is operated at a pressure greater than or equal to about 5 bar. In some embodiments, the carbon particles have a smaller surface area than carbon particles formed in the reactor when operated at a pressure of less than about 5 bar. In some embodiments, the carbon particles have about 60% of the surface area as compared to carbon particles formed in the reactor when operated at a pressure of about 1 bar In some embodiments, the reactor is operated at a pressure greater than or equal to about 10 bar. In some embodiments, the carbon particles have a smaller surface area than carbon particles formed in the reactor when operated at a pressure of less than about 10 bar. In some embodiments, the carbon particles have about 35% of the surface area as compared to carbon particles formed in the reactor when operated at a pressure of about 1 bar. In some embodiments, the reactor is operated at a pressure greater than or equal to about 20 bar. In some embodiments, the carbon particles have a smaller surface area than carbon particles formed in the reactor when operated at a pressure of less than about 20 bar. In some embodiments, the reactor is operated at a pressure greater than or equal to about 30 bar. In some embodiments, the carbon particles have a smaller surface area than carbon particles formed in the reactor when operated at a pressure of less than about 30 bar. In some embodiments, the method further comprises increasing the surface area of the carbon particles using one or more additives. In some embodiments, the one or more additives comprise hydrocarbon gases. In some embodiments, the one or more additives comprise silicon. In some embodiments, the one or more additives comprise aromatic additives. In some embodiments, the reactor is an oxygen-free environment. In some embodiments, the reactor comprises less than about 2% molecular oxygen by volume or mole. In some embodiments, yield of the carbon particles in the reactor is greater than yield of carbon particles formed in the reactor when operated at a pressure of about 1 bar. In some embodiments, the carbon particles are produced at a yield of greater than 75%. In some embodiments, the carbon particles are produced at a yield of greater than 85%. In some embodiments, the carbon particles are produced at a yield of greater than 90%. In some embodiments, the carbon particles are produced at a yield of greater than 99%. In some embodiments, a yield of the carbon particles in the reactor is greater than a yield of carbon particles formed in a reactor of the same size as the reactor when operated at a pressure of less than 1.5 bar.

In another aspect, the present disclosure provides a method of producing hydrogen in a reactor, comprising: (a) using one or more electrodes to generate a plasma in the reactor; and (b) injecting, through one or more injectors, a hydrocarbon into the reactor such that the hydrocarbon contacts the plasma, thereby producing the hydrogen, wherein the reactor is operated at a pressure greater than or equal to about 1.5 bar.

In some embodiments, the one or more electrodes comprise AC electrodes. In some embodiments, the one or more electrodes comprise DC electrodes. In some embodiments, the method further comprises producing carbon particles. In some embodiments, the method further comprises continuously producing the hydrogen and the carbon particles. In some embodiments, the method further comprises producing the hydrogen and the carbon particles in a once-through, single stage process. In some embodiments, the hydrocarbon is a gas. In some embodiments, the hydrocarbon comprises natural gas. In some embodiments, the hydrocarbon is heated upon contact with the plasma. In some embodiments, the reactor is operated at a pressure greater than or equal to about 5 bar. In some embodiments, the reactor is operated at a pressure greater than or equal to about 10 bar. In some embodiments, the reactor is operated at a pressure greater than or equal to about 20 bar. In some embodiments, the reactor is operated at a pressure greater than or equal to about 30 bar. In some embodiments, the reactor is an oxygen-free environment. In some embodiments, the reactor comprises less than about 2% molecular oxygen by volume or mole.

In another aspect, the present disclosure provides a method of producing carbon particles in a reactor, comprising: (a) using one or more electrodes to generate a plasma in the reactor; and (b) injecting, through one or more injectors, a hydrocarbon into the reactor, thereby producing the carbon particles, wherein the reactor is operated at a pressure greater than or equal to about 1.5 bar.

In some embodiments, the one or more electrodes comprise AC electrodes. In some embodiments, the one or more electrodes comprise DC electrodes. In some embodiments, the method further comprises producing hydrogen. In some embodiments, the method further comprises continuously producing the hydrogen and the carbon particles. In some embodiments, the method further comprises producing the hydrogen and the carbon particles in a once-through, single stage process. In some embodiments, the hydrocarbon is a gas. In some embodiments, the hydrocarbon comprises natural gas. In some embodiments, the hydrocarbon is heated upon contact with the plasma. In some embodiments, the carbon particles have a smaller surface area than carbon particles formed in the reactor when operated at a pressure of less than about 1.5 bar. In some embodiments, the carbon particles have about 90% of the surface area as compared to carbon particles formed in the reactor when operated at a pressure of about 1 bar. In some embodiments, the reactor is operated at a pressure greater than or equal to about 5 bar. In some embodiments, the carbon particles have a smaller surface area than carbon particles formed in the reactor when operated at a pressure of less than about 5 bar. In some embodiments, the carbon particles has about 60% of the surface area as compared to carbon particles formed in the reactor when operated at a pressure of about 1 bar. In some embodiments, the reactor is operated at a pressure greater than or equal to about 10 bar. In some embodiments, the carbon particles have a smaller surface area than carbon particles formed in the reactor when operated at a pressure of less than about 10 bar. In some embodiments, the carbon particles have about 35% of the surface area as compared to carbon particles formed in the reactor when operated at a pressure of about 1 bar. In some embodiments, the reactor is operated at a pressure greater than or equal to about 20 bar. In some embodiments, the carbon particles have a smaller surface area than carbon particles formed in the reactor when operated at a pressure of less than about 20 bar. In some embodiments, the reactor is operated at a pressure greater than or equal to about 30 bar. In some embodiments, the carbon particles have a smaller surface area than carbon particles formed in the reactor when operated at a pressure of less than about 30 bar. In some embodiments, the method further comprises increasing the surface area of the carbon particles using one or more additives. In some embodiments, the one or more additives comprise hydrocarbon gases. In some embodiments, the one or more additives comprise silicon. In some embodiments, the one or more additives comprise aromatic additives. In some embodiments, the reactor is an oxygen-free environment. In some embodiments, the reactor comprises less than about 2% molecular oxygen by volume or mole. In some embodiments, yield of the carbon particles in the reactor is greater than yield of carbon particles formed in the reactor when operated at a pressure of about 1 bar. In some embodiments, the carbon particles are produced at a yield of greater than 75%. In some embodiments, the carbon particles are produced at a yield of greater than 85%. In some embodiments, the carbon particles are produced at a yield of greater than 90%. In some embodiments, the carbon particles are produced at a yield of greater than 99%. In some embodiments, a yield of the carbon particles in the reactor is greater than a yield of carbon particles formed in a reactor of the same size as the reactor when operated at a pressure of less than 1.5 bar.

In another aspect, the present disclosure provides a method of producing hydrogen in a reactor, comprising: (a) using one or more electrodes to generate a plasma in the reactor; and (b) injecting, through one or more injectors, a hydrocarbon into the reactor, thereby producing the hydrogen, wherein the reactor is operated at a pressure greater than or equal to about 1.5 bar.

In some embodiments, the one or more electrodes comprise AC electrodes. In some embodiments, the one or more electrodes comprise DC electrodes. In some embodiments, the method further comprises producing carbon particles. In some embodiments, the method further comprises continuously producing the hydrogen and the carbon particles. In some embodiments, the method further comprises producing the hydrogen and the carbon particles in a once-through, single stage process. In some embodiments, the hydrocarbon is a gas. In some embodiments, the hydrocarbon comprises natural gas. In some embodiments, the hydrocarbon is heated upon contact with the plasma. In some embodiments, the reactor is operated at a pressure greater than or equal to about 5 bar. In some embodiments, the reactor is operated at a pressure greater than or equal to about 10 bar. In some embodiments, the reactor is operated at a pressure greater than or equal to about 20 bar. In some embodiments, the reactor is operated at a pressure greater than or equal to about 30 bar. In some embodiments, the reactor is an oxygen-free environment. In some embodiments, the reactor comprises less than about 2% molecular oxygen by volume or mole. In some embodiments, the hydrocarbon is injected adjacent to the one or more electrodes. In some embodiments, the hydrocarbon is injected within 500 millimeters (mm) of the one or more electrodes. In some embodiments, the plasma comprises at least a portion of the hydrocarbon. In some embodiments, after the injecting in (b), the hydrocarbon contacts the plasma. In some embodiments, each of the one or more electrodes comprises an electrode tip, and wherein the one or more electrode tips are located in a single plane in the reactor. In some embodiments, the hydrocarbon is injected into the reactor upstream of the single plane of the one or more electrode tips. In some embodiments, the hydrocarbon is injected into the reactor at the single plane of the one or more electrode tips. In some embodiments, the hydrocarbon is injected into the reactor downstream of the single plane of the one or more electrode tips. In some embodiments, a pressure at an injection tip of the one or more injectors is greater than 1.5 bar. In some embodiments, the operating pressure of the reactor is within 10 percent of the pressure at the injector tip. In some embodiments, greater than 30% of the carbon particles are carbon particles with an equivalent sphere diameter of less than about 2 micrometers. In some embodiments, greater than 30% of the carbon particles are carbonaceous nanoparticles. In some embodiments, greater than 90% of the carbon injected into the reactor forms either carbon particles with an equivalent sphere diameter of less than about 2 micrometers or carbon particles with an equivalent sphere diameter of less than about 2 micrometers. In some embodiments, the combination of larger carbon particles and carbon particles comprises greater than 98% carbon. In some embodiments, the produced hydrogen has a purity of greater than 99.9%. In some embodiments, the method further comprises directing the produced hydrogen to a purification system without compressing or repressurizing the produced hydrogen. In some embodiments, the method further comprises using a pressure lock system to isolate the carbon particles, remove at least a portion of hydrogen produced, and depressurize the atmosphere surrounding the carbon particles to less than 1.5 bar. In some embodiments, the carbon particles comprise a carbon-14 ratio that is greater than a carbon-14 ratio of carbon particles produced using a fossil fuel hydrocarbon feedstock. In some embodiments, each of the one or more electrodes has a mass of greater than 10 kg. In some embodiments greater than 3 tons/hour of carbon particles are produced. In some embodiments, greater than 1 ton/hour of hydrogen is produced. In some embodiments, the method further comprises adding a sheath gas to the reactor. In some embodiments, the addition of sheath gas increases a yield of carbonaceous nanoparticles as compared to a method without the addition of sheath gas. In some embodiments, the wear rate of the one or more electrodes is less than 10 kg per electrode per ton of carbon particles produced. In some embodiments, the hydrocarbon is injected adjacent to the one or more electrodes. In some embodiments, the hydrocarbon is injected within 500 millimeters (mm) of the one or more electrodes. In some embodiments, the plasma comprises at least a portion of the hydrocarbon. In some embodiments, after the injecting in (b), the hydrocarbon contacts the plasma. In some embodiments, each of the one or more electrodes comprises an electrode tip, and wherein the one or more electrode tips are located in a single plane in the reactor. In some embodiments, the hydrocarbon is injected into the reactor upstream of the single plane of the one or more electrode tips. In some embodiments, the hydrocarbon is injected into the reactor at the single plane of the one or more electrode tips. In some embodiments, the hydrocarbon is injected into the reactor downstream of the single plane of the one or more electrode tips. In some embodiments, a pressure at an injection tip of the one or more injectors is greater than 3.3 bar. In some embodiments, the operating pressure of the reactor is within 10 percent of the pressure at the injector tip In some embodiments, the produced hydrogen has a purity of greater than 99.9%. In some embodiments, the method further comprises directing the produced hydrogen to a purification system without compressing or repressurizing the produced hydrogen. In some embodiments, each of the one or more electrodes has a mass of greater than 20 kg. In some embodiments, greater than 1 ton/hour of hydrogen is produced. In some embodiments, the method further comprises adding a sheath gas to the reactor. In some embodiments, the hydrocarbon comprises a liquid hydrocarbon. In some embodiments, the hydrocarbon is used as a plasma gas to generate the plasma. These and additional embodiments are further described below.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGs.” herein), of which:

FIG. 1 shows an example of a system in accordance with the present disclosure;

FIG. 2 shows a schematic representation of an example of an apparatus in accordance with the present disclosure;

FIG. 3 shows a schematic representation of another example of an apparatus in accordance with the present disclosure;

FIG. 4 shows a schematic representation of another example of an apparatus in accordance with the present disclosure;

FIG. 5 shows a flow chart of a process for making carbon particles in a reactor, according to some embodiment;

FIG. 6 shows a flowchart of a process for producing hydrogen in a reactor, according to some embodiments;

FIG. 7 is a plot of an example of a range of reactor pressures versus normalized surface area measurements, according to an embodiment;

FIG. 8 is a plot of an example demonstration of the increase in reactor yield with increasing reactor pressure, according to an embodiment;

FIG. 9 shows a computer system that is programmed or otherwise configured to implement methods provided herein; and

FIG. 10 is an example of a high pressure degassing apparatus, according to some embodiments.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed. It shall be understood that different aspects of the invention can be appreciated individually, collectively, or in combination with each other.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

The present disclosure provides systems and methods for affecting chemical changes. Affecting such chemical changes may include making, for example, carbonaceous material and/or hydrogen using the systems and methods of the present disclosure. A carbonaceous material may be solid. A carbonaceous material may comprise or be, for example, carbon particles, a carbon-containing compound or a combination thereof. A carbonaceous material may include, for example carbon black. The systems (e.g., apparatuses) and methods of the present disclosure, and processes implemented with the aid of the systems and methods herein, may allow continuous production of, for example, carbonaceous material and/or hydrogen. The processes may include converting a feedstock (e.g., one or more hydrocarbons). The systems and methods described herein may include heating one or more hydrocarbons rapidly to form, for example, carbonaceous material and/or hydrogen. For example, one or more hydrocarbons may be heated rapidly to form carbon particles and/or hydrogen. Hydrogen may in some cases refer to majority hydrogen (H₂). For example, some portion of this hydrogen may also contain methane (e.g., unspent methane) and/or various other hydrocarbons (e.g., ethane, propane, ethylene, acetylene, benzene, toluene, polycyclic aromatic hydrocarbons (PAHs) such as naphthalene, etc.).

The present disclosure provides examples of such systems and methods, including, for example, the use of plasma technology in pyrolytic decomposition (e.g., pyrolytic dehydrogenation) of natural gas to carbonaceous material (e.g., solid carbonaceous material, such as, for example, carbon particles) and/or hydrogen. Pyrolytic decomposition (e.g., pyrolytic dehydrogenation) may refer to thermal decomposition of materials at elevated temperatures (e.g., temperatures greater than about 800° C.) in an inert or oxygen-free environment or atmosphere. The temperature of a reactor can be increased to increase the conversion of feedstock into carbon particles and/or hydrogen. The temperature of a reactor can be increased to selectivity between hydrogen and carbon particles. The temperature of a reactor can be tuned to increase or decrease the surface area of carbon particles. Increasing temperatures can increase the kinetic rates of feedstock decomposition as well as the intermediate operations which can produce formation of carbon particles and hydrogen. Increasing reactor temperature can increase the rate of carbon particle aging and can reduce reactor wall fouling. This may be due to reducing the time before the carbon particles are chemically inert.

Processes in accordance with the present disclosure may include heating one or more gases with electrical energy (e.g., from a DC or AC source). Any description of heating a gas or of heating one or more gases herein may equally apply to heating a gaseous mixture (e.g., at least 50% by volume gaseous) with a corresponding composition at least in some configurations. The gaseous mixture may comprise, for example, a mixture of individual gases and/or liquids, or a mixture of individual gas-liquid mixtures. Any description of a gas herein may equally apply to a liquid or gas-liquid mixture with a corresponding composition at least in some configurations. The one or more gases may be heated by an electric arc. The one or more gases may be heated by Joule heating (e.g., resistive heating, induction heating, or a combination thereof). The one or more gases may be heated by Joule heating and by an electric arc (e.g., downstream of the Joule heating). The one or more gases may be heated by heat exchange, by Joule heating, by an electric arc, or any combination thereof. The one or more gases may be heated by heat exchange, by Joule heating, by combustion, or any combination thereof. At least one of the one or more gases may comprise a hydrocarbon. The one or more gases may include a feedstock. The one or more gases may include the feedstock alone or in combination with other gases (which other gases, alone or in combination with other gases which are not heated, may be referred to herein as “process gases”). The one or more gases may include the feedstock and at least one process gas. Individual gases among the one or more gases may be provided (e.g., to a reactor) separately or in various combinations. At least a subset of the one or more gases may be pre-heated. For example, the hydrocarbon (e.g., the feedstock) may be pre-heated (e.g., from a temperature of about 25° C.) to a temperature from about 100° C. to about 800° C. prior to being provided to the thermal generator. The process may include heating at least a subset of the one or more gases (e.g., the feedstock) at suitable reaction conditions (e.g., in the reactor). The carbonaceous material and/or hydrogen may be produced in a substantially inert or substantially oxygen-free environment or atmosphere. At least a subset of the one or more gases (e.g., the feedstock) may be heated in a substantially oxygen-free environment or atmosphere. A substantially oxygen-free environment or atmosphere may comprise, for example, less than or equal to about 10%, 9%, 8%, 7%, 6%, 5%, 4%, 3%, 2% or 1% molecular oxygen by volume or mole. A substantially oxygen-free environment or atmosphere may comprise, for example, less than or equal to about 10%, 9%, 8%, 7%, 6%, 5%, 4%, 3%, 2% or 1% atomic oxygen by volume or mole. The heating may affect removal of hydrogen from the feedstock. The feedstock (e.g., one or more hydrocarbons) may be cracked such that at least about 80% by moles of the hydrogen originally chemically attached through covalent bonds to a hydrocarbon may be homoatomically bonded as diatomic hydrogen. Homoatomically bonded may refer to the bond being between two atoms that are the same (e.g., as in diatomic hydrogen (H₂)). C—H may be a heteroatomic bond. A hydrocarbon may go from heteroatomically bonded C—H to homoatomically bonded H—H and C—C. Reaction products may include an effluent stream of, for example, gases and solids which exits the reactor. The effluent stream comprising the reaction products may be cooled. The reaction products may be at least partially separated (e.g., after cooling). For example, solid carbonaceous material may be at least partially separated from the other (e.g., gaseous) reaction products.

The systems described herein may comprise plasma generators. The plasma generators may utilize a gas or gaseous mixture (e.g., at least 50% by volume gaseous). The plasma generators may utilize a gas or gaseous mixture (e.g., at least 50% by volume gaseous) where the gas is reactive and corrosive in the plasma state. The plasma generators may be plasma torches. The systems described herein may comprise plasma generators energized by a DC or AC source. The gas or gas mixture may be supplied directly into a zone in which an electric discharge produced by the DC or AC source is sustained. The plasma may have a composition as described elsewhere herein (e.g., in relation to composition of the one or more gases). The plasma may be generated using arc heating. The plasma may be generated using inductive heating. The plasma may be generated using DC electrodes. The plasma may be generated using AC electrodes. For example, a plurality (e.g., 3 or more) of AC electrodes may be used (e.g., with the advantage of more efficient energy consumption as well as reduced heat load at the electrode surface).

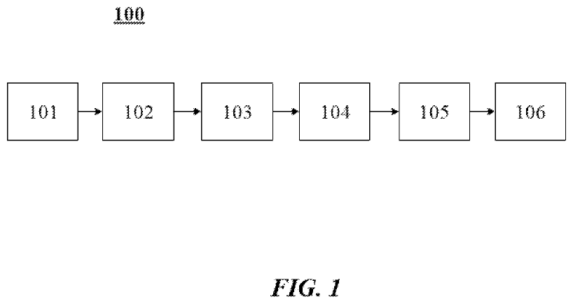

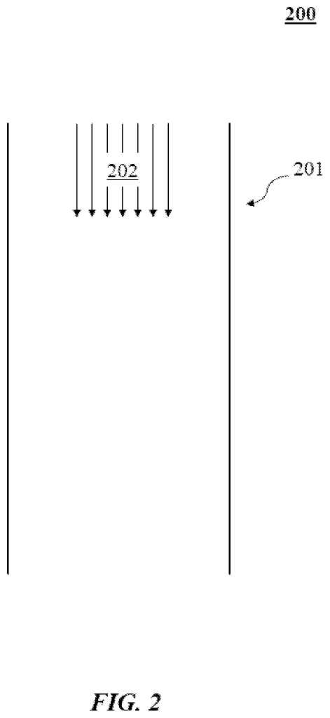

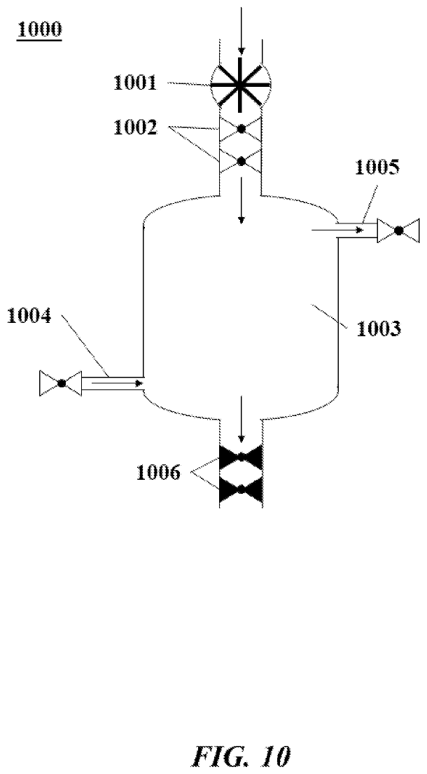

FIG. 1 shows an example of a system 100 in accordance with the present disclosure. The system may include a thermal generator (e.g., a plasma generator) 101. The thermal generator 101 may heat at least a subset of one or more gases (e.g., a feedstock) at suitable reaction conditions in a reactor (or furnace) 102 to affect removal of hydrogen from the feedstock. The reactor 102 may contain the thermal generator (e.g., a plasma generator) 101. Heating (e.g., electrical heating, such as, for example, plasma heating) and reaction may be implemented in one chamber (also “single chamber,” “single stage reactor” or “single stage process” herein). The reactor 102 may comprise one or more constant diameter regions/sections, one or more converging regions/sections, one or more diverging regions/sections, one or more additional components, or any combination thereof. Such regions/sections, and/or additional components, may be combined in various ways to implement the heating and reaction in accordance with the present disclosure. Such implementations may include, but are not limited to, configurations as described in relation to the schematic representations in FIGS. 2, 3 and 4. For example, the reactor may have a substantially constant diameter (e.g., at least about 70%, 80%, 90%, 95% or 99% of the reactor's length may be of a constant diameter. At least a subset of the one or more gases (e.g., a feedstock) may be added to the thermal generator 101. The feedstock (e.g., one or more hydrocarbons) may begin to crack and decompose before being fully converted into solid carbonaceous material. Heat may (e.g., also) be provided through latent radiant heat from the wall of the reactor. This may occur through heating of the walls (or portions thereof) via externally provided energy or through the heating of the walls (or portions thereof) from the heated gas(es) in the reactor. Reaction products may be cooled after manufacture. A quench (e.g., comprising a process gas) may be used to cool the reaction products. For example, a quench comprising a majority of hydrogen gas may be used. The quench may be added (e.g., injected) in the reactor 102. A heat exchanger 103 (e.g., connected to the reactor 102) may cool an effluent stream comprising the reaction products. In the heat exchanger, gaseous reaction products may be exposed to a large surface area and thus allowed to cool while solid carbonaceous material may be simultaneously transported through the process. The solid carbonaceous material may pass through a filter (e.g., a main filter) 104 (e.g., connected to the heat exchanger 103). The filter may allow, for example, more than 50% of the gaseous reaction products to pass through, capturing substantially all of the solid carbonaceous material on the filter. For example, at least about 98% by weight of the solid carbonaceous material may be captured on the filter. The gaseous reaction products may be provided or coupled to one or more uses, recycled back into the reactor (e.g., as a process gas), or any combination thereof. The solid carbonaceous material with residual gaseous reaction products may pass through a degas (e.g., degas chamber or apparatus) 105 (e.g., connected to the filter 104) where the amount of combustible gas is reduced (e.g., to less than about 10% by volume). The solid carbonaceous material may then pass through a back end 106. The back end equipment 106 may include, for example, one or more of a pelletizer (e.g., connected to the degas apparatus 105), a binder mixing tank (e.g., connected to the pelletizer), a dryer (e.g., connected to the pelletizer) and/or a bagger as non-limiting example(s) of components or unit operations. For example, the solid carbonaceous material (e.g., carbon black) may be pelletized in the pelletizer and dried in the dryer (e.g., mixed with water with a binder and then formed into pellets. followed by removal of the majority of the water in a dryer). The solid carbonaceous material may also pass through classifier(s), hammer mill(s) and/or other size reduction equipment (e.g., so as to reduce the proportion of grit in the product). As non-limiting examples of other components or unit operations, one or more of a conveying process or conveying unit, purge filter unit (e.g., which may filter solid carbonaceous material out of steam vented from the dryer), dust filter unit (e.g., which may collect dust from other equipment), other process filter, other hydrogen/tail gas removal unit, cyclone, other bulk separation (e.g., solid/gas separation) unit, off quality product blending unit, etc. (e.g., other components or unit operations described elsewhere herein) may be added or substituted in the system 100. Components or unit operations may be added or removed as appropriate. For example, the system 100 may include at least one or more heat exchangers 103, one or more filters 104 and a back end 106 comprising solid handling equipment. The solid handling equipment may include, for example, a cooled solid carbon collection screw conveyor, an air locking and purge system, a pneumatic conveying system, a mechanical conveying system (e.g., a conveyor belt auger or elevator), a classifying mill, and a product storage vessel. The carbon particles may be collected at a single location (e.g., all of the carbon particles may be collected at one location). The carbon particles may be collected at a plurality of locations (e.g., a portion of the carbon particles can be collected at a first location and a second portion of the carbon particles can be collected at a second location). In some cases, when the carbon particles are collected at a plurality of locations, a first location of the plurality of locations can be a catchpot. The catchpot can be configured to collect larger carbon particles that do not convey through the system (e.g., due to gravity). In some cases, the catchpot can operate using a pressure lock and dump apparatus (e.g., the high pressure degassing apparatus of FIG. 10). In some cases, when the carbon particles are collected at a plurality of locations, smaller carbon particles can be captured using an apparatus such as that of FIG. 10. The apparatus of FIG. 10 may be placed downstream of the catchpot. In some cases, a first catchpot can be located under (e.g., directly under, near to directly under) the reactor. In some cases, a second particle collector (e.g., catchpot, etc.) can be located downstream from the reactor. The second particle collector can be configured to collect smaller carbon particles conveyed by an effluent stream of the reactor. The first catchpot can be configured to catch larger carbon particles as described elsewhere herein (e.g., carbon particles with an equivalent sphere diameter of greater than about 2 micrometers). The second particle collector may be configured to catch carbon particles as described elsewhere herein (e.g., carbon particles with an equivalent sphere diameter of at most about 2 micrometers).

Other examples of separation units or hydrogen/tail gas removal units include, but are not limited to, pressure swing adsorption devices, cryogenic separation devices, molecular sieves, or the like, or any combination thereof. The pressure swing adsorption (PSA) device may be configured to separate and/or purify components from a gas stream (e.g., components from a gas stream generated by a reactor as described elsewhere herein). The PSA device can comprise use of adsorption and the characteristics of the different components of a gas mixture (e.g., molecular size, dipole moment, etc.) to selectively pass through components of the mixture. For example, a PSA device can be used to separate hydrogen out of a reactor gas mixture. In this example, the PSA device can use the small size of hydrogen to separate the hydrogen by passing the gas mixture over a porous bed (e.g., a bed of porous zeolite) that can act as a sieve. In this example, the hydrogen can pass through the sieve while larger species in the gas mixture are filtered out by becoming trapped in the sieves. In this example, the sieves can saturate with the larger gasses, at which point the bed can be removed and regenerated through removal of the larger gas species. A plurality of PSA devices can be used in parallel or in series. For example, a plurality of PSA devices can be set in parallel to permit continuous processing of gases while a subset of the PSA devices are being regenerated. A PSA device can be operated at a pressure of at least about 1.5, 10, 11, 12, 13, 14, 15, 16, 17, 18, 19, 20, 21, 22, 23, 24, 25, 26, 27, 28, 29, 30, or more bar gauge (barg). A PSA device can be operated at a pressure of at most about 30, 29, 28, 27, 26, 25, 24, 23, 22, 21, 20, 19, 18, 17, 16, 15, 14, 13, 12, 11, 10, 5, or fewer bar gauge (barg). A PSA device can be operated at a pressure in a range as defined by any two of the proceeding values. For example, a PSA device can be operated at a pressure between about 13 and about 24 barg. A PSA device may be operated at a gas inlet temperature of at least about −50, −45, −40, −35, −30, −25, −20, −15, −10, −5, 0, 5, 10, 15, 20, 25, 30, 35, 40, 45, 50, 55, 60, 65, 70, or more degrees Celsius. A PSA device may be operated at a gas inlet temperature of at most about 70, 65, 60, 55, 50, 45, 40, 35, 30, 25, 20, 15, 10, 5, 0, −5, −10, −15, −20, −25, −30, −45, −50, or less degrees Celsius. For example, the PSA may operate at a temperature above where a component of the gas mixture condenses.

A cryogenic separation device may be configured to separate components (e.g., different gasses of a gas mixture) through utilization of cryogenic (e.g., sub-ambient) temperatures. For example, a cryogenic separation device can be configured to cool a mixture until all components of the mixture have condensed, and subsequently utilize increases in temperature and/or pressure to remove (e.g., boil off) components in order to separate them. Cryogenic separation may provide high purities of the components of the gas mixture (e.g., hydrogen).

Once separated from a gas mixture, hydrogen from the reactor can be further purified. In some cases, the hydrogen is of sufficient purity upon removal from the gas mixture (e.g., no further purification may be performed). In some cases, the hydrogen is purified by a PSA device, a cryogenic separation device, molecular sieves, or the like, or any combination thereof. In some cases, the hydrogen can be pressurized upon removal from the gas mixture. For example, the hydrogen can be pressurized prior to being fed into a purification apparatus. Subsequent to purification, the hydrogen can be of a purity of at least about 50, 60, 70, 80, 85, 90, 91, 92, 93, 94, 95, 96, 97, 98, 99, 99.9, 99.99, 99.999, 99.9999, 99.99999, or more percent (e.g., percent by mole, weight, or volume). Subsequent to purification, the hydrogen can be at a purity of at most about 99.99999, 99.9999, 99.999, 99.99, 99.9, 99, 98, 97, 96, 95, 94, 93, 92, 91, 90, 85, 80, 70, 60, 50, or less percent (e.g., percent by mole, weight, or volume). The gas removed from the hydrogen during purification may comprise hydrocarbons (e.g., methane, ethane, ethylene, acetylene, propene, benzene, toluene, naphthalene, anthracene, etc.), hydrogen, nitrogen, hydrogen cyanide, carbon monoxide, noble gases (e.g., argon, neon, krypton, etc.), or the like, or any combination thereof. The gas removed from the hydrogen may comprise at least about 1, 2, 3, 4, 5, 6, 7, 8, 9, 10, 11, 12, 13, 14, 15, 16, 17, 18, 19, 20, 21, 22, 23, 24, 25, or more percent by mole of the gas mixture. The gas removed from the hydrogen may comprise at most about 25, 24, 23, 22, 21, 20, 19, 18, 17, 16, 15, 14, 13, 12, 11, 10, 9, 8, 7, 6, 5, 4, 3, 2, 1, or less percent by mole of the gas mixture.

FIG. 2 shows a schematic representation of an example of an apparatus 200 in accordance with the present disclosure that includes a cross-sectional view of an example of a reactor 200. A feedstock may be provided to the reactor 201. At least one process gas (e.g., any non-feedstock gas provided to a reactor in accordance with the present disclosure) may (e.g., also) be provided to the reactor 200. A hot gas 202 may be generated (e.g., in the reactor) through the use of a thermal generator (e.g., in an upper portion of the reactor (not shown)). For example, the hot gas 202 may be generated in an upper portion of the reactor through the use of one or more AC electrodes (e.g., three or more AC electrodes), through the use of DC electrodes (e.g., concentric DC electrodes), or through the use of a resistive or inductive heater. The hot gas may be generated by heating at least a subset of one or more gases (e.g., a feedstock alone or in combination with at least one process gas) using the AC electrodes, the DC electrodes, or the resistive or inductive heater. The heating may include directly heating a hydrocarbon (e.g., the feedstock). For example, the hydrocarbon (e.g., the feedstock) may be added to the thermal generator (e.g., at a pressure described elsewhere herein). For example, the hydrocarbon (e.g., the feedstock) may be added through direct injection into the plasma. As described elsewhere herein, the reactor 201 may contain the thermal generator (not shown). In this configuration, the hydrocarbon (e.g., the feedstock) may be heated in the same chamber (also “single chamber,” “single stage reactor” or “single stage process” herein) as the carbonaceous material and/or hydrogen is produced (e.g., plasma and carbonaceous material/hydrogen formation may be in the same reactor). The reactor 201 may be configured to allow at least a portion of the flow or the total flow in at least a portion of the reactor to be substantially axial, substantially radial or a combination thereof. The reactor 201 (or at least a portion thereof, such as, for example, at least a portion of an inner wall of the reactor) may comprise a liner (e.g., a refractory liner). A hydrocarbon (e.g., the feedstock) may be provided to the reactor. For example, the hydrocarbon (e.g., the feedstock) may be injected into the reactor through one or more injectors (e.g., injectors 305, 406, 407 or any combination thereof). Alternatively, or in addition, the hydrocarbon (e.g., the feedstock) may be provided through one or more inlet ports (e.g., in a wall of the reactor 200). Any description to number and/or location of injectors herein may equally apply to inlet ports at least in some configurations, and vice versa. One or more process gases may be provided through one or more inlet ports (e.g., the same or different than the hydrocarbon or feedstock) and/or through at least a subset of the one or more injectors. A given process gas may be provided together with a feedstock, separately from the feedstock or a combination thereof (e.g., the given process gas may be provided with the feedstock, and either the given process gas or a different process gas may be provided separately from the feedstock (e.g., as purge)). A given process gas may or may not be heated by the thermal generator. A process gas provided with the feedstock and/or in parallel with the feedstock may be heated. A process gas may modify the environment or atmosphere in/around at least a portion of the reactor, the thermal generator, inlet port(s) and/or injector(s), purge at least a portion of the reactor, the thermal generator, inlet port(s) and/or injector(s), or any combination thereof. For example, an inlet port, an array of inlet ports or a plenum (e.g., at the top of a reactor, such as, for example, the reactors 201, 301 and/or 301) may be used to purge at least a portion of the reactor (e.g., one or more walls), one or more other inlet ports and/or one or more injectors (e.g., as described in greater detail elsewhere herein). Any description of an inlet port herein may equally apply to an array of inlet ports or a plenum at least in some configurations, and vice versa. The one or more gases (e.g., a feedstock alone or in combination with at least one process gas) that are heated with electrical energy may comprise substantially only the hydrocarbon (e.g., the feedstock). For example, the one or more gases that are heated with electrical energy may comprise the feedstock, and either no process gases, or process gas(es) at purge level(s) and/or some process gas(es) added with the feedstock (e.g., the one or more gases that are heated with electrical energy may comprise the feedstock and process gas(es) at purge level(s) only). As the hydrocarbon (e.g., feedstock) that is heated comprises substantially only freshly supplied hydrocarbon, such a configuration may be referred to herein as a “once-through process.” Alternatively, the one or more gases that are heated with electrical energy may comprise greater level(s) of process gas(es). Levels of a given process gas or a sum of a subset or of all process gases (e.g., on a per mole of feedstock basis) and percentage of process gas(es) heated with electrical energy may be as described elsewhere herein. In some cases, where DC electrodes are used, two electrodes can be used. In some cases, where DC electrodes are used, a multiple of two electrodes can be used (e.g., 2, 4, 6, etc.). AC electrodes may be used in single phase or triple phase configurations. When a single phase AC configuration is used, a multiple of two electrodes may be used (e.g., 2, 4, 6, 8, etc.). When a triple phase AC configuration is used, a multiple of 3 electrodes can be used (e.g., 3, 6, 9, etc.). Each electrode can have an associated injector. For example, a triple phase three electrode configuration can comprise three injectors positioned above the plane of the electrodes.

For example, hydrogen and carbonaceous material (e.g., carbon particles) may be produced in a once-through, single stage process comprising adding hydrocarbon (e.g., natural gas) to a plasma generator at above atmospheric pressures. The hydrocarbon may be added through direct injection (e.g., direct injection of the feedstock) into the plasma generated by the plasma generator. The energy from the plasma generator may remove hydrogen from the hydrocarbon. The process may additionally include the use of heat exchangers, filters and solid handling equipment. The solid handling equipment may include a cooled solid carbon collection screw conveyor, an air locking and purge system, a pneumatic conveying system, a classifying mill, and a product storage vessel.

The wear rate of the electrodes may be reduced or minimized as a result of the systems and methods described herein. The wear rate may be defined in units of kg of wear (the mass of electrode lost as a result of performing the systems and methods described herein) per electrode per ton of carbon produced. In some cases, the wear rate of the one or more electrodes is about 5 kg of wear per electrode per ton of carbon produced to about 20 kg of wear per electrode per ton of carbon produced. In some cases, the wear rate of the one or more electrodes is about 5 kg of wear per electrode per ton of carbon produced to about 10 kg of wear per electrode per ton of carbon produced, about 5 kg of wear per electrode per ton of carbon produced to about 20 kg of wear per electrode per ton of carbon produced, or about 10 kg of wear per electrode per ton of carbon produced to about 20 kg of wear per electrode per ton of carbon produced. In some cases, the wear rate of the one or more electrodes is about 5 kg of wear per electrode per ton of carbon produced, about 10 kg of wear per electrode per ton of carbon produced, or about 20 kg of wear per electrode per ton of carbon produced. In some cases, the wear rate of the one or more electrodes is at least about 5 kg of wear per electrode per ton of carbon produced, or about 10 kg of wear per electrode per ton of carbon produced. In some cases, the wear rate of the one or more electrodes is at most about 10 kg of wear per electrode per ton of carbon produced, or about 20 kg of wear per electrode per ton of carbon produced.

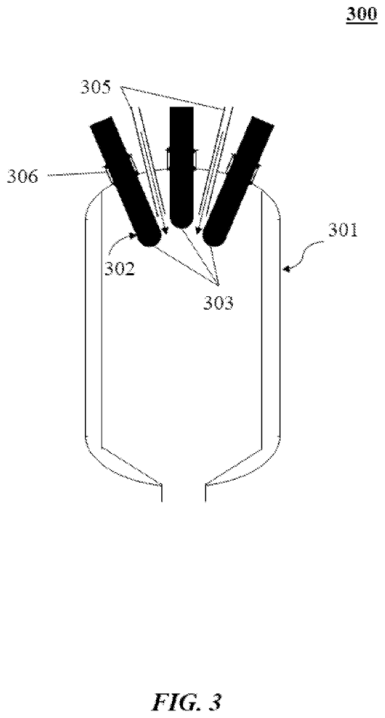

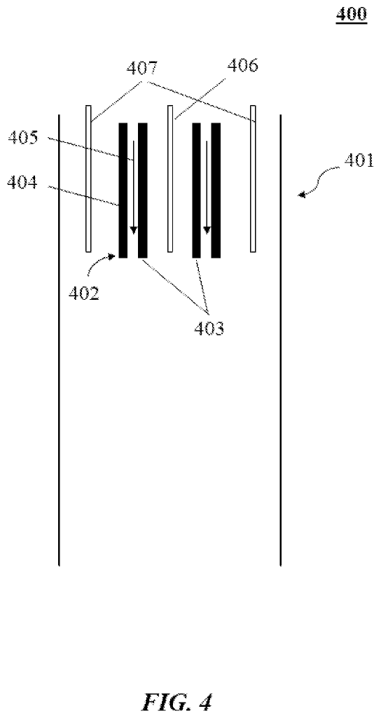

FIG. 3 shows a schematic representation of another example of an apparatus 300 in accordance with the present disclosure that includes a cross-sectional view of an example of a reactor 301 comprising a thermal generator 302. The thermal generator 302 may comprise AC electrodes 303 of electrically conductive material. The AC electrodes 303 may be arranged, for example, in a single-phase or a 3-phase configuration. One or more gases (e.g., a feedstock alone or in combination with at least one process gas) 304 may flow between the electrodes where an arc may then excite it into the plasma state. At least a subset of one or more gases (e.g., a feedstock alone or in combination with at least one process gas) may be heated as described elsewhere herein (e.g., in relation to FIG. 2). A hydrocarbon (e.g., the feedstock) may be injected through various injector configurations described herein (with appropriate modification(s)) (e.g., as described in relation to FIG. 2 and FIG. 4). For example, the hydrocarbon (e.g., the feedstock) may be injected at injectors 305 (e.g., between the electrodes 302). The reactor may comprise an injector associated with each electrode. In FIG. 3, the additional injector may be omitted for clarity (e.g., the injector may be occluded by the electrode). The apparatus may comprise one or more electrode sliding seals 306. The electrode sliding seals may be configured to provide a gas seal of the apparatus (e.g., sealed such that gas does not escape from the apparatus when under pressure. The electrode sliding seal may be configured to permit movement of the electrode within the apparatus while maintaining the gas seal of the apparatus. For example, the electrodes can be fed into the apparatus as they are worn away, and the electrode sliding seal can maintain the atmosphere of the apparatus while the electrodes are being fed into the apparatus. A purge gas can be applied through the sliding seal 306 to maintain the environment of the reactor and prevent ingress of atmospheric gasses through the seal. The purge gas can be as described elsewhere herein (e.g., a process gas). The sliding seal may be configured to permit movement of the electrode within the reactor. For example, the seal can permit movement of the electrode into and/or out of the reactor. In another example, the seal can permit movement of the electrode within the three-dimensional space of the reactor. The hydrocarbon can be injected adjacent to one or more electrodes. The hydrocarbon can be injected in close proximity to one or more electrodes. In some cases, the hydrocarbon is injected at a distance from the electrodes of about 1 mm to about 1,000 mm. In some cases, the hydrocarbon is injected at a distance from the electrodes of about 1 mm to about 5 mm, about 1 mm to about 10 mm, about 1 mm to about 100 mm, about 1 mm to about 1.000 mm, about 5 mm to about 10 mm, about 5 mm to about 100 mm, about 5 mm to about 1,000 mm, about 10 mm to about 100 mm, about 10 mm to about 1,000 mm, or about 100 mm to about 1,000 mm. In some cases, the hydrocarbon is injected at a distance from the electrodes of about 1 mm, about 5 mm, about 10 mm, about 100 mm, or about 1,000 mm. In some cases, the hydrocarbon is injected at a distance from the electrodes of at least about 1 mm, about 5 mm, about 10 mm, or about 100 mm. In some cases, the hydrocarbon is injected at a distance from the electrodes of at most about 5 mm, about 10 mm, about 100 mm, or about 1,000 mm.

The pressure at the tip of any of the injectors may be the same as the pressure of the surrounding reactor. In some cases, the pressure at the tip of any of the injectors is greater than the pressure of the surrounding reactor. In some cases, the pressure at the tip of any of the injectors is within 20% of the pressure of the surrounding reactor. In some cases, the pressure at the tip of any of the injectors is within 10% of the pressure of the surrounding reactor. In some cases, the pressure at the tip of any of the injectors is within 5% of the pressure of the surrounding reactor. In some cases, the pressure at the tip of any of the injectors is within 1% of the pressure of the surrounding reactor.

The electrodes and/or the injectors may possess an angle of inclination (e.g., an angle between the long axis of the electrode or injector and the length axis of the reactor) of at least about 0, 5, 10, 15, 20, 25, 30, 35, 40, 45, 50, 55, 60, 65, 70, 75, 80, 85, 90, or more degrees. The electrodes and/or the injectors may possess an angle of inclination of at most about 90, 85, 80, 75, 70, 65, 60, 55, 50, 45, 40, 35, 30, 25, 20, 15, 10, 5, 0, or less degrees. The electrodes and/or injectors may possess an angle on inclination in a range as defined by any two of the proceeding values. For example, the electrodes and injectors may have an angle of inclination between about 15 and about 30 degrees. Higher angles of inclination may provide increased torch stability. The injectors can comprise a heat resistant material (e.g., metals, tungsten, graphite, metal carbides, ceramic materials, alumina, silica, aluminosicates, glasses, etc.). For example, the injectors can be formed of metal (e.g., copper, stainless steel, Inconel, etc.). The injectors can be water cooled. The injectors can be configured to provide additional additives in addition to the feedstocks to the reactor.

The reactor may comprise one or more optional sheath gas injectors. The sheath gas injectors can be configured to provide an inert gas configured to provide a barrier to coking within the reactor chamber. The inert gas may be as described elsewhere herein. The sheath gas can be located on the internal reactor side. The sheath gas may be located higher than the electrode tips. The sheath gas may be introduced to the reactor via a slit around the circumference of the reactor configured to enable gas flow out of the slit into close proximity to the interior surface of the reactor.

The electrodes may be cylindrical in shape. The electrodes may be movable via a screw system working in concert with the sliding seal associated with the electrode. The screw system may be water cooled. Use of the movable electrodes may enable continuous operation of the reactor. For example, additional electrode material can be joined to the ends of the electrodes outside of the reactor and, as the electrodes are degraded in the reactor, new electrode material can be fed into the reactor. In this example, the ability to add new electrode material outside of the reactor during reactor operation can provide for continuous or substantially continuous operation of the reactor. In some cases, the electrodes comprise graphite (e.g., synthetic graphite, natural graphite, semi graphite, etc.), carbonaceous materials and resins or other binders, carbon composite materials, carbon fiber materials, or the like, or any combination thereof. The electrodes may be at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, or more inches in diameter. The electrodes may be at most about 40, 35, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1, or fewer inches in diameter. The electrodes may be at least about 1, 2, 3, 4, 5, 6, 7, 8, 9, 10, 11, 12, 13, 14, 15, 16, 17, 18, 19, 20, 21, 22, 23, 24 or more feet in length. The electrodes may be at most about 24, 23, 22, 21, 20, 19, 18, 17, 16, 15, 14, 13, 12, 11, 10, 9, 8, 7, 6, 5, 4, 3, 2, 1, or less feet in length. The distance between the center point of the electrode arc and the wall of the reactor may be at least about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2. 2.3. 2.4, 2.5, 2.6. 2.7, 2.8, 2.9, 3, 3. 1, 3.2, 3.3, 3.4, 3.5, 3.6, 3.7, 3.8, 3.9, 4, or more meters. The distance between the center point of the electrode arc and the wall of the reactor may be at most about 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, or fewer meters. Too great of a distance can generate recirculation of gasses back into the plasma region, while too short of a distance can cause the wall of the reactor to degrade. In some cases, an electrode can have a mass of at least about 20, 100, 200, 300, 400, 500, 600, 700, 800, 900, 1,000, 10,000, 20,000, 30,000 40,000, or more kilograms. In some cases, an electrode can have a mass of at most about 40,000, 30,000, 20,000, 10,000, 1,000, 900, 800, 700, 600, 500, 400, 300, 200, 100, 20, or fewer kilograms.

FIG. 4 shows a schematic representation of another example of an apparatus 400 in accordance with the present disclosure in accordance with the present disclosure that includes a cross-sectional view of an example of a reactor 401 comprising a thermal generator 402. The thermal generator 402 may comprise inner and outer DC electrodes 403 and 404, respectively, that comprise concentrically arranged (e.g., as concentric rings) electrically conductive material. One or more gases (e.g., a feedstock alone or in combination with at least one process gas) 405 may flow between the electrodes 403 and 404 where an arc may then excite it into the plasma state. The arc may be controlled through the use of a magnetic field which moves the arc in a circular fashion rapidly around the electrode tips. The electrodes 403 and 404 may or may not be oriented parallel to an axis of the reactor 401 and/or to each other. The electrode 403 and/or the electrode 404 may comprise a complex shape. A hydrocarbon (e.g., the feedstock) may be injected through various injector configurations described herein (with appropriate modification(s)) (e.g., as described in relation to FIG. 2 and FIG. 3). For example. the hydrocarbon (e.g., the feedstock) may be injected at injector 406 (e.g., through the center of the concentric electrodes), at injectors 407, or any combination thereof.

With continued reference to FIG. 2. FIG. 3 and FIG. 4, an injector configuration in accordance with the present disclosure may include a central injector (e.g., injector 406), one or more (e.g., an array of) injectors located inside (e.g., replacing or in addition to the central injector) or among the electrodes of the thermal generator (e.g., injectors 305) and/or outside (e.g., peripherally/surrounding) the electrodes of the thermal generator (e.g., injectors 407), or any combination thereof. The one or more (e.g., the array of) injectors located inside the electrodes, among the electrodes and/or outside the electrodes of the thermal generator may be oriented parallel to an axis of a reactor (e.g., injectors 406 and 407) or at an angle (e.g., inward) against the axis of the reactor (e.g., injectors 305) and/or each other. As described elsewhere herein, a given injector flow may instead be provided through an inlet port in some instances. For example, a hydrocarbon (e.g., feedstock) may be provided as the one or more gases 304 or injected via injector 406. A tip of an injector may be located above the bottom plane of the electrodes, below the plane or in the same plane (e.g., at the same height as the plane). For example, in FIG. 3 and FIG. 4, tips of injectors 305, 406 and 407 are shown as above the bottom plane of the electrodes. One or more injectors in a given injector configuration may be cooled (e.g., a central injector, such as, for example, injector 406 may be cooled). The injector configuration may comprise, for example, greater than or equal to 1, 2, 3, 4, 5, 6, 7, 8, 9, 10, 11, 12, 13, 14, 15, 16, 17, 18, 19, 20, 21, 22, 23, 24 or 25 injectors. Alternatively, or in addition, the injector configuration may comprise, for example, less than or equal to 50, 40, 30, 25, 24, 23, 22, 21, 20, 19, 18, 17, 16, 15, 14, 13, 12, 11, 10, 9, 8, 7, 6, 5, 4 or 3 injectors. For example, the injector configuration may comprise a central injector and an array of injectors around the central injector (located inside the electrodes, among the electrodes and/or outside the electrodes), an array of injectors (located inside the electrodes, among the electrodes and/or outside the electrodes) with no central injector, etc. The injectors can be configured to provide hydrocarbons in a plurality of injection streams (e.g., at least about 2, 3, 4, 5, 6, 7, 8, 9, 10, or more injection streams). The plurality of injection streams can be above a plane of the electrodes within a reactor, while a second set of injectors can be configured to inject below the plane of the electrodes. For example, a first set of injectors can provide a hydrocarbon feedstock above the electrodes in a reactor, while a second set of injectors can provide a hydrocarbon feedstock in a plane below the electrodes in the reactor. The plane of the electrodes may be a plane perpendicular to the length of the reactor such that the tips of each electrode are within at least about 0.01, 0.05, 0.1, 0.2, 0.3, 0.4, 0.5, or more meters of the plane. The plane of the electrodes may be a plane perpendicular to the length of the reactor such that the tips of each electrode are within at most about 0.5, 0.4, 0.3, 0.2, 0.1, 0.05, 0.01, or less meters of the plane. In some cases, instead of a plasma heating source as described elsewhere herein, a joule heating (e.g., resistive heating) source may be used. For example, a resistive heating element can be placed in the reactor instead of the plasma torch and can be configured to provide the heat used in the reaction.

Injectors in accordance with the present disclosure (or portions thereof) (e.g., injectors 305, 406, 407 or any combination thereof) may comprise or be one or more suitable materials, such as, for example, copper, stainless steel, graphite, alloys (e.g., of high temperature corrosion resistant metals) and/or other similar materials (e.g., with high melting points and good corrosion resistance). The injector(s) may be cooled via a cooling fluid. The injector(s) may be cooled by, for example, water or a non-oxidizing liquid (e.g., mineral oil, ethylene glycol, propylene glycol, synthetic organic fluids such as, for example, DOWTHERM™ materials, etc.).

Thermal generators (e.g., plasma generators) and/or reactors of the present disclosure (or portions thereof) may comprise or be made of, for example: copper, tungsten, graphite (e.g., extruded or molded), molybdenum, rhenium, nickel, chromium, iron, silver, other refractory or high temperature metals, or alloys thereof (e.g., copper-tungsten alloy. rhenium-tungsten alloy, molybdenum-tungsten alloy or copper-rhenium alloy; carbide alloys such as, for example, tungsten carbide, molybdenum carbide or chromium carbide; etc.); boron nitride, silicon carbide, alumina, alumina silica blends, or other high temperature ceramics; other oxygen-resistant refractory material; or any combination thereof. At least a portion of an electrode(s) (e.g., one or more of the electrodes 303, 403 and 404) of a thermal generator (e.g., plasma generator) may comprise one or more of the aforementioned materials. An electrode in accordance with the present disclosure may have a suitable geometry (e.g., cylindrical, bar with an ellipsoid or polygonal cross-section, sharp or rounded ends, etc.). The electrode geometry may be customized. Alternatively, the thermal generator may be configured to allow integration of existing electrode geometries (e.g., used in steelmaking). The electrode material (e.g., chemical composition, grain structure, etc.) and/or geometry may be configured to enhance survivability (e.g., strength, thermal flexibility, etc.). At least a portion of a reactor (e.g., at least a portion of a wall or liner) in accordance with the present disclosure may comprise one or more of the aforementioned materials (e.g., the reactor may be refractory-lined). The reactor (e.g., wall or liner of the reactor) may comprise one or more sections comprising different materials. For example, the refractory liner may comprise one or more sections comprising different refractories, such as, for example, a section that may be too hot for a given refractory and another section comprising the given (e.g., standard) refractory.

A thermal generator (e.g., plasma generator) in accordance with the present disclosure may be configured such that, for example, less than or equal to about 750 kilograms (kg), 500 kg, 400 kg, 300 kg, 200 kg, 100 kg, 90 kg, 80 kg, 70 kg, 60 kg, 50 kg, 40 kg, 30 kg, 20 kg, 15 kg, 10 kg, 5 kg, 2 kg, 1.75 kg, 1.5 kg, 1.25 kg, 1 kg, 0.9 kg, 0.8 kg, 0.7 kg, 0.6 kg, 500 grams (g), 400 g, 300 g, 200 g, 100 g, 50 g, 20 g, 10 g, 5 g, 2 g or 1 g of electrode material (e.g., electrodes 303, and/or electrodes 403 and 404) is consumed per ton (e.g., metric ton) of carbonaceous material (e.g., solid carbonaceous material) produced. Alternatively, or in addition, the thermal generator (e.g., plasma generator) of the present disclosure may be configured such that, for example, greater than or equal to about 0 g, 1 g, 1.25 kg, 1.5 kg, 1.75 kg, 2 g, 5 g, 10 g, 20 g, 50 g, 100 g, 200 g, 300 g, 400 g, 500 g, 0.6 kg, 0.7 kg, 0.8 kg, 0.9 kg, 1 kg, 2 kg, 5 kg, 10 kg, 15 kg, 20 kg, 30 kg, 40 kg, 50 kg, 60 kg, 70 kg, 80 kg, 90 kg, 100 kg, 200 kg, 300 kg, 400 kg or 500 kg of electrode material (e.g., electrodes 303, and/or electrodes 403 and 404) is consumed per ton (e.g., metric ton) of carbonaceous material (e.g., solid carbonaceous material) produced.

Electrodes (e.g., AC and/or DC electrodes of a plasma generator) in accordance with the present disclosure (or portions thereof) (e.g., electrodes 303, and/or electrodes 403 and 404) may be placed at a given distance (also “gap” or “gap size” herein) from each other. The gap between the electrodes (or portions thereof) may be, for example, less than or equal to about 40 millimeters (mm), 39 mm, 38 mm, 37 mm, 36 mm, 35 mm, 34 mm, 33 mm, 32 mm, 31 mm, 30 mm, 29 mm, 28 mm, 27 mm, 26 mm, 25 mm, 24 mm, 23 mm, 22 mm, 21 mm, 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, 2 mm or 1 mm. Alternatively, or in addition, the gap between the electrodes (or portions thereof) may be, for example, greater than or equal to about 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm or 35 mm.

The hydrocarbon feedstock may include any chemical with formula CₙHₓ or CₙHₓO_{y}. where n is an integer; x is between (i) 1 and 2n+2 or (ii) less than 1 for fuels such as coal, coal tar, pyrolysis fuel oils, and the like; and y is between 0) and n. The hydrocarbon feedstock may include, for example, simple hydrocarbons (e.g., methane, ethane, propane, butane, etc.), aromatic feedstocks (e.g., benzene, toluene, xylene, methyl naphthalene, pyrolysis fuel oil, coal tar, coal, heavy oil, oil, bio-oil, bio-diesel, other biologically derived hydrocarbons, and the like), unsaturated hydrocarbons (e.g., ethylene, acetylene, butadiene, styrene, and the like), oxygenated hydrocarbons (e.g., ethanol, methanol, propanol, phenol, ketones, ethers, esters, and the like), or any combination thereof. These examples are provided as non-limiting examples of acceptable hydrocarbon feedstocks which may further be combined and/or mixed with other components for manufacture. A hydrocarbon feedstock may refer to a feedstock in which the majority of the feedstock (e.g., more than about 50% by weight) is hydrocarbon in nature. The reactive hydrocarbon feedstock may comprise at least about 70% by weight methane, ethane, propane or mixtures thereof. The hydrocarbon feedstock may comprise or be natural gas. The hydrocarbon may comprise or be methane, ethane, propane or mixtures thereof. The hydrocarbon may comprise methane, ethane, propane, butane, acetylene, ethylene, carbon black oil, coal tar, crude coal tar, diesel oil, benzene and/or methyl naphthalene. The hydrocarbon may comprise (e.g., additional) polycyclic aromatic hydrocarbons. The hydrocarbon feedstock may comprise one or more simple hydrocarbons, one or more aromatic feedstocks, one or more unsaturated hydrocarbons, one or more oxygenated hydrocarbons, or any combination thereof. The hydrocarbon feedstock may comprise, for example, methane, ethane, propane, butane, pentane, natural gas, benzene, toluene, xylene, ethylbenzene, naphthalene, methyl naphthalene, dimethyl naphthalene, anthracene, methyl anthracene, other monocyclic or polycyclic aromatic hydrocarbons, carbon black oil, diesel oil, pyrolysis fuel oil, coal tar, crude coal tar, coal, heavy oil, oil, bio-oil, bio-diesel, other biologically derived hydrocarbons, ethylene, acetylene, propylene, butadiene, styrene, ethanol, methanol, propanol, phenol, one or more ketones, one or more ethers, one or more esters, one or more aldehydes, or any combination thereof. The feedstock may comprise one or more derivatives of feedstock compounds described herein, such as, for example, benzene and/or its derivative(s), naphthalene and/or its derivative(s), anthracene and/or its derivative(s), etc. The hydrocarbon feedstock (also “feedstock” herein) may comprise a given feedstock (e.g., among the aforementioned feedstocks) at a concentration (e.g., in a mixture of feedstocks) greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by weight, volume or mole. Alternatively, or in addition, the feedstock may comprise the given feedstock at a concentration (e.g., in a mixture of feedstocks) less than or equal to about 100% 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4,5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25ppm, 10 ppm, 5 ppm or 1 ppm by weight, volume or mole. The feedstock may comprise additional feedstocks (e.g., in a mixture of feedstocks) at similar or different concentrations. Such additional feedstocks may be selected, for example, among the aforementioned feedstocks not selected as the given feedstock. The given feedstock may itself comprise a mixture (e.g., such as natural gas).

A process gas may comprise, for example, oxygen, nitrogen, argon, helium, air, hydrogen, carbon monoxide, water, hydrocarbon (e.g., methane, ethane, unsaturated and/or any hydrocarbon described herein in relation to the feedstock) etc. (used alone or in mixtures of two or more). In some examples, a process gas may be inert. A process gas may comprise or be freshly supplied gas (e.g., delivered, or supplied from storage such as, for example, a cylinder or a container), recycled gaseous reaction products (e.g., as described in greater detail elsewhere herein), or any combination thereof. The process gas may comprise, for example, oxygen, nitrogen (e.g., up to about 30% by volume), argon (e.g., up to about 30% Ar), helium, air, hydrogen (e.g., greater than or equal to about 50%, 60%, 70%, 80% and 90%, up to about 100% by volume), carbon monoxide (e.g., at least about 1 ppm by volume and up to about 30%), water, hydrocarbon (e.g., methane, ethane, unsaturated, benzene and toluene or similar monoaromatic hydrocarbon, polycyclic aromatic hydrocarbons such as anthracene and its derivatives, naphthalene and its derivatives, methyl naphthalene, methyl anthracene, coronene, pyrene, chrysene, fluorene and the like, and/or any hydrocarbon described herein in relation to the feedstock; for example, at least about 1 ppm by volume and up to about 30% CH₄ by volume, at least about 1 ppm and up to about 30% C₂H₂, at least about 1 ppm C₂H₄ by volume, at least about 1 ppm benzene by volume, and/or at least about 1 ppm polyaromatic hydrocarbon by volume), HCN (e.g., at least about 1 ppm by volume and up to about 10% by volume), NH₃ (e.g., at least about 1 ppm by volume and up to about 10% by volume), etc. (used alone or in mixtures of two or more). The process gas may comprise at least about 60% hydrogen up to about 100% hydrogen (by volume) and may further comprise up to about 30% nitrogen, up to about 30% CO, up to about 30% CH₄, up to about 10% HCN, up to about 30% C₂H₂, and up to about 30% Ar. For example, the process gas may be greater than about 60% hydrogen. Additionally, the process gas may also comprise polycyclic aromatic hydrocarbons such as anthracene, naphthalene, coronene, pyrene, chrysene, fluorene, and the like. In addition, the process gas may have benzene and toluene or similar monoaromatic hydrocarbon components present. For example, the process gas may comprise greater than or equal to about 90% hydrogen, and about 0.2% nitrogen, about 1.0% CO, about 1.1% CH₄, about 0.1% HCN and about 0.1% C₂H₂. The process gas may comprise greater than or equal to about 80% hydrogen and the remainder may comprise some mixture of the aforementioned gases, polycyclic aromatic hydrocarbons, monoaromatic hydrocarbons and other components. The process gas may comprise greater than or equal to about 50% hydrogen by volume. The process gas may comprise greater than about 70% H₂ by volume and may include at least one or more of the gases HCN, CH₄, C₂H₄, C₂H₂, CO, benzene or polyaromatic hydrocarbon (e.g., naphthalene and/or anthracene) at a level of at least about 1 ppm. The polyaromatic hydrocarbon may comprise, for example, naphthalene, anthracene and/or their derivatives. The polyaromatic hydrocarbon may comprise, for example, methyl naphthalene and/or methyl anthracene. The process gas may comprise a given process gas (e.g., among the aforementioned process gases) at a concentration (e.g., in a mixture of process gases) greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by weight, volume or mole. Alternatively, or in addition, the process gas may comprise the given process gas at a concentration (e.g., in a mixture of process gases) less than or equal to about 100%, 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4,5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by weight, volume or mole. The process gas may comprise additional process gases (e.g., in a mixture of process gases) at similar or different concentrations. Such additional process gases may be selected, for example, among the aforementioned process gases not selected as the given process gas. The given process gas may itself comprise a mixture. The process gas may be used as a purge gas. The purge gas may be an inert gas used to purge a reactor or carbon particles (e.g., to remove non-inert gasses). The purge gas may be provided at a pressure greater than an operating pressure of the reactor (e.g., the purge gas may be provided at a higher pressure and regulated to a lower pressure in the reactor).

The feedstock (e.g., hydrocarbon) may be provided to the system (e.g., to a reactor, such as, for example, reactor 102, 201, 301 or 401 described herein) at a rate of, for example, greater than or equal to about 50 grams per hour (g/hr), 100 g/hr, 250 g/hr, 500 g/hr, 750 g/hr, 1 kilogram per hour (kg/hr), 2 kg/hr, 5 kg/hr, 10 kg/hr, 15 kg/hr, 20 kg/hr, 25 kg/hr, 30 kg/hr, 35 kg/hr, 40 kg/hr, 45 kg/hr, 50 kg/hr, 55 kg/hr, 60 kg/hr, 65 kg/hr, 70 kg/hr, 75 kg/hr, 80 kg/hr, 85 kg/hr, 90 kg/hr, 95 kg/hr, 100 kg/hr, 150 kg/hr, 200 kg/hr, 250 kg/hr, 300 kg/hr, 350 kg/hr, 400 kg/hr, 450 kg/hr, 500 kg/hr, 600 kg/hr, 700 kg/hr, 800 kg/hr, 900 kg/hr, 1,000 kg/hr, 1,100 kg/hr, 1,200 kg/hr, 1,300 kg/hr, 1,400 kg/hr, 1,500 kg/hr, 1,600 kg/hr, 1,700 kg/hr, 1,800 kg/hr, 1,900 kg/hr, 2,000 kg/hr, 2,100 kg/hr, 2,200 kg/hr, 2,300 kg/hr, 2,400 kg/hr, 2,500 kg/hr, 3,000 kg/hr, 3,500 kg/hr, 4,000 kg/hr, 4,500 kg/hr, 5,000 kg/hr, 6,000 kg/hr, 7,000 kg/hr, 8,000 kg/hr, 9,000 kg/hr or 10,000 kg/hr. Alternatively, or in addition, the feedstock (e.g., hydrocarbon) may be provided to the system (e.g., to the reactor) at a rate of, for example, less than or equal to about 10,000 kg/hr, 9,000 kg/hr, 8,000 kg/hr, 7,000 kg/hr, 6,000 kg/hr, 5,000 kg/hr, 4,500 kg/hr, 4,000 kg/hr, 3,500 kg/hr, 3,000 kg/hr, 2,500 kg/hr, 2,400 kg/hr, 2,300 kg/hr, 2,200 kg/hr, 2,100 kg/hr, 2,000 kg/hr, 1,900 kg/hr, 1,800 kg/hr, 1,700 kg/hr, 1,600 kg/hr, 1,500 kg/hr, 1,400 kg/hr, 1,300 kg/hr, 1,200 kg/hr, 1,100 kg/hr, 1,000 kg/hr, 900 kg/hr, 800 kg/hr, 700 kg/hr, 600 kg/hr, 500 kg/hr, 450 kg/hr, 400 kg/hr, 350 kg/hr, 300 kg/hr, 250 kg/hr, 200 kg/hr, 150 kg/hr, 100 kg/hr, 95 kg/hr, 90 kg/hr, 85 kg/hr, 80 kg/hr, 75 kg/hr, 70 kg/hr, 65 kg/hr, 60 kg/hr, 55 kg/hr, 50 kg/hr, 45 kg/hr, 40 kg/hr, 35 kg/hr, 30 kg/hr, 25 kg/hr, 20 kg/hr, 15 kg/hr, 10 kg/hr, 5 kg/hr, 2 kg/hr, 1 kg/hr, 750 g/hr, 500 g/hr, 250 g/hr or 100 g/hr.

A dilution may be a ratio of a total number of moles of processes gas (e.g., dilutant gas) to the total number of moles of carbon atoms (e.g., feedstock carbon atoms) injected into a reactor (e.g., during a process described elsewhere herein). A dilution factor below about 2 may provide benefits in the operation of a plasma-based pyrolysis reactor. Achieving a dilution factor below about 2 may comprise use of a hydrocarbon as a plasma gas. For example, the hydrocarbon can be used as both the plasma gas and the feedstock gas. A reactor with a dilution factor below about 2 may have recycle and purge gasses in close vicinity of the electrodes in amounts that provide a dilution factor below about 2. The purge gasses may be present to pressurize the reactor and/or pressurize sliding seals on the electrodes of the reactor. The apparatuses and methods of the present disclosure may achieve a dilution factor of at least about 0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, or more. The apparatuses and methods of the present disclosure may achieve a dilution factor of at most about 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, or less.

A recycle gas may be supplied to the reactors and methods of the present disclosure. The recycle gas may be at least a component of a plasma gas. For example, the recycle gas can be provided to a reactor to be heated as a portion of the plasma gas. The recycle gas may be a process gas as described elsewhere herein. The recycle gas may be at least a portion of a gas that is produced by a reactor. For example, the recycle gas can be the gas output by the reactor during the generation of carbon particles and/or hydrogen. The recycle gas may comprise hydrogen (e.g., at least about 10, 20, 30, 40, 50, 60, 70, 80, 90, 99, or more percent hydrogen). nitrogen, argon, carbon monoxide, water, hydrocarbons, or the like, or any combination thereof. The recycle gas may be gas rejected from a purification process as described elsewhere herein. For example, impurities removed from the hydrogen generated in a high pressure degas apparatus can be used as a recycle gas. The recycle gas may be at an elevated (e.g., above ambient) temperature. For example, the recycle gas can be provided at a high temperature to reduce the amount of energy lost from the plasma in heating the recycle gas. The use of the recycle gas may provide increased lifetime of the electrodes in a reactor as well as increased efficiency by recycling reactants (e.g., hydrocarbons) back into the reactor. For example, the hydrocarbons can be recycled back into the reactor, thereby improving the conversion rate of the hydrocarbons. The recycle gas may be introduced into the reactor via a sheath and/or blanket flow of recycled gas and/or another inert gas as described elsewhere herein. Such a flow can prevent deposition of gaseous and/or solid carbon onto the electrodes and/or other surfaces of the reactor (e.g., reactor walls). In some cases, the recycle gas can be pressurized (e.g., repressurized) prior to introduction into the reactor. For example, the recycle gas can be passed through a compressor prior to being injected into the reactor. The recycle gas can be pressurized to the pressures described elsewhere herein.

A given process gas or a sum of a subset or of all process gases may be provided to the system (e.g., to a reactor, such as, for example, reactor 102, 201, 301 or 401 described herein) at a rate of, for example, greater than or equal to about 0 normal cubic meter/hour (Nm³/hr), 0.1 Nm³/hr, 0.2 Nm³/hr, 0.5 Nm³/hr, 1 Nm³/hr, 1.5 Nm³/hr, 2 Nm³/hr, 5 Nm³/hr, 10 Nm³/hr, 25 Nm³/hr, 50 Nm³/hr, 75 Nm³/hr, 100 Nm³/hr, 150 Nm³/hr, 200 Nm³/hr, 250 Nm³/hr, 300 Nm³/hr, 350 Nm³/hr, 400 Nm³/hr, 450 Nm³/hr, 500 Nm³/hr, 550 Nm³/hr, 600 Nm³/hr, 650 Nm³/hr, 700 Nm³/hr, 750 Nm³/hr, 800 Nm³/hr, 850 Nm³/hr, 900 Nm³/hr, 950 Nm³/hr, 1,000 Nm³/hr, 2,000 Nm³/hr, 3,000 Nm³/hr, 4,000 Nm³/hr, 5,000 Nm³/hr, 6,000 Nm³/hr, 7,000 Nm³/hr, 8,000 Nm³/hr, 9,000 Nm³/hr, 10,000 Nm³/hr, 12,000 Nm³/hr, 14,000 Nm³/hr, 16,000 Nm³/hr, 18,000 Nm³/hr, 20,000 Nm³/hr, 30,000 Nm³/hr, 40,000 Nm³/hr, 50,000 Nm³/hr, 60,000 Nm³/hr, 70,000 Nm³/hr, 80,000 Nm³/hr, 90,000 Nm³/hr or 15,000 Nm³/hr. Alternatively, or in addition, the given process gas or a sum of a subset or of all process gases may be provided to the system (e.g., to the reactor) at a rate of, for example, less than or equal to about 100,000 Nm³/hr, 90,000 Nm³/hr, 80,000 Nm³/hr, 70,000 Nm³/hr, 60,000 Nm³/hr, 50,000 Nm³/hr, 40,000 Nm³/hr, 30,000 Nm³/hr, 20,000 Nm³/hr, 18,000 Nm³/hr, 16,000 Nm³/hr, 14,000 Nm³/hr, 12,000 Nm³/hr, 10,000 Nm³/hr, 9,000 Nm³/hr, 8,000 Nm³/hr, 7,000 Nm³/hr, 6,000 Nm³/hr, 5,000 Nm³/hr, 4,000 Nm³/hr, 3,000 Nm³/hr, 2,000 Nm³/hr, 1,000 Nm³/hr, 950 Nm³/hr, 900 Nm³/hr, 850 Nm³/hr, 800 Nm³/hr, 750 Nm³/hr, 700 Nm³/hr, 650 Nm³/hr, 600 Nm³/hr, 550 Nm³/hr, 500 Nm³/hr, 450 Nm³/hr, 400 Nm³/hr, 350 Nm³/hr, 300 Nm³/hr, 250 Nm³/hr, 200 Nm³/hr, 150 Nm³/hr, 100 Nm³/hr, 75 Nm³/hr, 50 Nm³/hr, 25 Nm³/hr, 10 Nm³/hr, 5 Nm³/hr, 2 Nm³/hr, 1.5 Nm³/hr, 1 Nm³/hr, 0.5 Nm³/hr or 0.2 Nm³/hr. The given process gas or a sum of a subset or of all process gases may be provided to the system (e.g., to the reactor) at such rates in combination with one or more feedstock flow rates described herein. A given process gas or a sum of a subset or of all process gases may be provided to the system (e.g., provided to a thermal generator, such as, for example, thermal generator 302 or 402, and/or provided elsewhere or in total to a reactor, such as, for example, reactor 102, 201, 301 or 401 described herein) at ratio of, for example, at greater than or equal to about 0, 0.0005, 0.001, 0.002, 0.005, 0.1, 0.2, 0.5, 1, 2, 3, 4, 5, 6, 7, 8, 9, 10, 15, 20, 25, 30, 35, 40, 45, 50, 75 or 90 moles of process gas(es) per mole of feedstock. Alternatively, or in addition, the given process gas or a sum of a subset or of all process gases may be provided to the system (e.g., provided to a thermal generator, such as, for example, thermal generator 302 or 402, and/or provided elsewhere or in total to a reactor, such as, for example, reactor 102, 201, 301 or 401 described herein) at ratio of, for example, less than or equal to about 100, 90, 75, 50, 45, 40, 35, 30, 25, 20, 15, 10, 9, 8, 7, 6, 5, 4, 3, 2, 1, 0.5, 0.2, 0.1, 0.005, 0.002, 0.001 or 0.0005 moles of process gas(es) per mole of feedstock. Less than or equal to about 100%, 75%, 50%, 40%, 30%, 20%, 10%, 5% or 1% of the process gas(es) provided to the system may be heated with electrical energy. Alternatively, or in addition, greater than or equal to about 0%, 1%, 5%, 10%, 20%, 30%, 40%, 50% or 75% of the process gas(es) provided to the system may be heated with electrical energy.

The one or more gases (e.g., the feedstock alone or in combination with at least one process gas) may be heated at a given pressure. The feedstock (e.g., alone or in combination with at least one process gas) may react at the given pressure (also “reaction pressure” herein). The heating and reaction may be implemented in a reactor at the given pressure (also “reactor pressure” herein). The pressure may be, for example, greater than or equal to about 0 bar, 0.5 bar, 1 bar, 1.1 bar, 1.2 bar, 1.3 bar, 1.4 bar, 1.5 bar, 1.6 bar, 1.7 bar, 1.8 bar, 1.9 bar, 2 bar, 2.1 bar, 2.2 bar, 2.3 bar, 2.4 bar, 2.5 bar, 2.6 bar, 2.7 bar, 2.8 bar, 2.9 bar, 3 bar, 3.1 bar, 3.2 bar, 3.3 bar, 3.4 bar, 3.5 bar, 3.6 bar, 3.7 bar, 3.8 bar, 3.9 bar, 4 bar, 4.5 bar, 5 bar, 6 bar, 7 bar, 8 bar, 9 bar, 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 35 bar, 40 bar, 45 bar, 50 bar, 55 bar, 60 bar, 65 bar, 70 bar, 75 bar, or more. Alternatively, or in addition, the pressure may be, for example, less than or equal to about 100 bar, 90 bar, 80 bar, 75 bar, 70 bar, 65 bar, 60 bar, 55 bar, 50 bar, 45 bar, 40 bar, 35 bar, 30 bar, 29 bar, 28 bar, 27 bar, 26 bar, 25 bar, 24 bar, 23 bar, 22 bar, 21 bar, 20 bar, 19 bar, 18 bar, 17 bar, 16 bar, 15 bar, 14 bar, 13 bar, 12 bar, 11 bar, 10 bar, 9 bar, 8 bar, 7 bar, 6 bar, 5 bar, 4 bar, 3.9 bar, 3.8 bar, 3.7 bar, 3.6 bar, 3.5 bar, 3.4 bar, 3.3 bar, 3.2 bar, 3.1 bar, 3 bar, 2.9 bar, 2.8 bar, 2.7 bar, 2.6 bar, 2.5 bar, 2.4 bar, 2.3 bar, 2.2 bar, 2.1 bar, 2 bar, 1.9 bar, 1.8 bar, 1.7 bar, 1.6 bar, 1.5 bar, 1.4 bar, 1.3 bar, 1.2 bar, 1.1 bar, or less. The pressure may be greater than atmospheric pressure (above atmospheric pressures). The pressure may be from about 1.5 bar to about 25 bar. The pressure may be from about 1 bar to about 70 bar. The pressure may be from about 5 bar to about 25 bar. The pressure may be from about 10 bar to about 20 bar. The pressure may be from about 5 bar to about 15 bar. The pressure may be greater than or equal to about 2 bar. The pressure may be greater than or equal to about 5 bar. The pressure may be greater than or equal to about 10 bar. The feedstock and/or the process gas(es) may be provided to the reactor at a suitable pressure (e.g., at least about 0.01%, 0.05%, 0.1%, 0.5%, 1%, 2%, 5%, 10%, 15%, 20%, 25% or 50% above reactor pressure, which pressure may depend on mode of injection, such as, for example, a higher pressure through an injector than through an inlet port). The feedstock and/or a process gas may be provided to the reactor, for example, at its respective delivery or storage (e.g., cylinder or container) pressure. The feedstock and/or a process may or may not be (e.g., additionally) compressed before it is provided to the reactor. The incoming feedstock may be provided at a pressure in a range as defined by any two of the proceeding pressure values. For example, the feedstock can be provided at a pressure of about 30 to about 35 bar, and can be metered down to a pressure of about 5 to about 15 bar. There may be a pressure drop across the reactor. For example, an inlet pressure of the reactor and an outlet pressure of the reactor may be different. The outlet pressure of the reactor may be a value selected from the proceeding list that is less than an inlet pressure selected from the proceeding list. For example, a reactor with an about 15 bar inlet pressure can have an about 14 bar outlet pressure. In another example, the inlet pressure can be about 4 bar and the outlet pressure can be about 2 bar. In another example, the inlet pressure can be about 35 bar and the outlet pressure can be about 30 bar. The pressure drop across the reactor can aid in the movement of gasses and/or carbon particles through the reactor.

The systems and methods described herein may produce a carbon product with a greater carbon-14 to carbon-12 ratio than an identical system that uses a fossil fuel hydrocarbon feedstock. For example, a carbon product produced using a fossil fuel feedstock can have a carbon-14 to carbon-12 ratio of greater than about 3*10⁻¹³. The carbon product as described herein can have a carbon-14 to carbon-12 ratio of greater than about 3*10⁻¹³. Carbon products produced by the systems and methods described herein may have over 10% more carbon-14 than carbon products produced from a fossil fuel hydrocarbon feedstock. Carbon products produced by the systems and methods described herein may have over 5% more carbon-14 than carbon products produced from a fossil fuel hydrocarbon feedstock.

The one or more gases (e.g., the feedstock alone or in combination with at least one process gas) may be subjected to (e.g., exposed to) a temperature of, for example, greater than or equal to about 1,000° C., 1,100° C., 1,200° C., 1,300° C., 1,400° C., 1,500° C., 1,600° C., 1,700°C., 1,800° C., 1,900° C., 2,000° C., 2050° C., 2,100° C., 2,150° C., 2,200° C., 2,250° C., 2,300° C., 2,350° C. 2,400° C., 2,450° C., 2,500° C., 2,550° C., 2,600° C., 2,650° C., 2,700° C., 2,750° C., 2,800° C. 2,850° C., 2,900° C., 2,950° C., 3,000° C., 3,050° C., 3,100° C., 3,150° C., 3,200° C. 3,250° C., 3,300° C., 3,350° C., 3,400° C. or 3,450° C. Alternatively, or in addition, the one or more gases (e.g., the feedstock alone or in combination with at least one process gas) may be heated to and/or the feedstock may be subjected to (e.g., exposed to) a temperature of, for example, less than or equal to about 3,500° C., 3,450° C., 3,400° C., 3,350° C., 3,300° C., 3,250° C. 3,200° C. 3,150° C., 3,100° C., 3,050° C., 3,000° C., 2,950° C., 2,900° C., 2,850° C., 2,800° C., 2,750° C. 2,700° C., 2,650° C., 2,600° C., 2,550° C., 2,500° C., 2,450° C., 2,400° C., 2,350° C. 2,300° C., 2,250° C., 2,200° C., 2,150° C., 2,100° C., 2050° C., 2,000° C., 1,900° C., 1,800° C., 1,700° C., 1,600° C., 1,500° C., 1,400° C., 1,300° C., 1,200° C. or 1,100° C. The one or more gases (e.g., the feedstock alone or in combination with at least one process gas) may be heated to such temperatures by a thermal generator (e.g., a plasma generator). The one or more gases (e.g., the feedstock alone or in combination with at least one process gas) gas may be electrically heated to such temperatures by the thermal generator (e.g., the thermal generator may be driven by electrical energy). Such thermal generators may have suitable powers.

Thermal generators may operate at suitable powers. The power may be, for example, greater than or equal to about 0.5 kilowatt (kW), 1 kW, 1.5 kW, 2 kW, 5 kW, 10 kW, 25 kW, 50 kW, 75 kW, 100 kW, 150 kW, 200 kW, 250 kW, 300 kW, 350 kW, 400 kW, 450 kW, 500 kW, 550 kW, 600 kW, 650 kW, 700 kW, 750 kW, 800 kW, 850 kW, 900 kW, 950 kW, 1 megawatt (MW), 1.05 MW, 1.1 MW, 1.15 MW, 1.2 MW, 1.25 MW, 1.3 MW, 1.35 MW, 1.4 MW, 1.45 MW, 1.5 MW, 1.6 MW, 1.7 MW, 1.8 MW, 1.9 MW, 2 MW, 2.5 MW, 3 MW, 3.5 MW, 4 MW, 4.5 MW, 5 MW, 5.5 MW, 6 MW, 6.5 MW, 7 MW, 7.5 MW, 8 MW, 8.5 MW, 9 MW, 9.5 MW, 10 MW, 10.5 MW, 11 MW, 11.5 MW, 12 MW, 12.5 MW, 13 MW, 13.5 MW, 14 MW, 14.5 MW, 15 MW, 16 MW, 17 MW, 18 MW, 19 MW, 20 MW, 25 MW, 30 MW, 35 MW, 40 MW, 45 MW, 50 MW, 55 MW, 60 MW, 65 MW, 70 MW, 75 MW, 80 MW, 85 MW, 90 MW, 95 MW or 100 MW. Alternatively, or in addition, the power may be, for example, less than or equal to about 100 MW, 95 MW, 90 MW, 85 MW, 80 MW, 75 MW, 70 MW, 65 MW, 60 MW, 55 MW, 50 MW, 45 MW, 40 MW, 35 MW, 30 MW, 25 MW, 20 MW, 19 MW, 18 MW, 17 MW, 16 MW, 15 MW, 14.5 MW, 14 MW, 13.5 MW, 13 MW, 12.5 MW, 12 MW, 11.5 MW, 11 MW, 10.5 MW, 10 MW, 9.5 MW, 9 MW, 8.5 MW, 8 MW, 7.5 MW, 7 MW, 6.5 MW, 6 MW, 5.5 MW, 5 MW, 4.5 MW, 4 MW, 3.5 MW, 3 MW, 2.5 MW, 2 MW, 1.9 MW, 1.8 MW, 1.7 MW, 1.6 MW, 1.5 MW, 1.45 MW, 1.4 MW, 1.35 MW, 1.3 MW, 1.25 MW, 1.2 MW, 1.15 MW, 1.1 MW, 1.05 MW, 1 MW, 950 kW, 900 kW, 850 kW, 800 kW, 750 kW, 700 kW, 650 kW, 600 kW, 550 kW, 500 kW, 450 kW, 400 kW, 350 kW, 300 kW, 250 kW, 200 kW, 150 kW, 100 kW, 75 kW, 50 kW, 25 kW, 10 kW, 5 kW, 2 kW, 1.5 kW or 1 kW.

Carbonaceous material (e.g., carbon particles) may be generated at a yield (e.g., yield based upon feedstock conversion rate, based on total hydrocarbon provided, on a weight percent carbon basis, or as measured by moles of product carbon vs. moles of reactant carbon) of, for example, greater than or equal to about 1%, 5%, 10%, 25%, 50%, 55%, 60%, 65%, 70%, 75%, 80%, 85%, 90%, 91%, 92%, 93%, 94%, 95%, 96%, 97%, 98%, 99%, 99.5% or 99.9%. Alternatively, or in addition, the carbonaceous material (e.g., carbon particles) may be generated at a yield (e.g., yield based upon feedstock conversion rate, based on total hydrocarbon provided, on a weight percent carbon basis, or as measured by moles of product carbon vs. moles of reactant carbon) of, for example, less than or equal to about 100%, 99.9%, 99.5%, 99%, 98%, 97%, 96%, 95%, 94%, 93%, 92%, 91%, 90%, 85%, 80%, 75%, 70%, 65%, 60%, 55%, 50%, 25% or 5%. The carbon particles may comprise larger carbon particles. The larger carbon particles may have an equivalent sphere greater than about 0.5, 0.6, 0.7, 0.75, 0.8, 0.9, 1, 1.1, 1.2, 1.25, 1.3, 1.,4, 1.5, 1.6, 1.7, 1.75, 1.8, 1.9, 2, 2.1, 2.2, 2.25, 2.3, 2.4, 2.5, 2.6, 2.7, 2.75, 2.8, 2.9, 3, 4, 5, or more micrometers and, for example, a nitrogen surface area (N₂SA) of less than about 50, 40, 30, 20, 15, 10, 5, or less square meters per gram (m²/g). For example, the larger carbon particles may have an equivalent sphere diameter of at least about 2 micrometers and an N2SA of less than about 15 square meters per gram. The larger carbon particles may be caught in a catchpot as described elsewhere herein. The carbon particles may comprise carbon particles with an equivalent sphere of less than about 5, 4, 3, 2.9, 2.8, 2.75, 2.7, 2.6, 2.5, 2.4, 2.3, 2.25, 2.2, 2.1, 2, 1.9, 1.8, 1.75, 1.7, 1.6, 1.5, 1.4, 1.3, 1.25, 1.2, 1.1, 1, 0.9, 0.8, 0.75, 0.7, 0.6 0.5, 0.4, 0.3, 0.25, 0.2, 0.1, or fewer micrometers. For example, the carbon particles can have an equivalent sphere diameter of less than about 2 micrometers. The carbon particles may have a ratio of larger carbon particles (e.g., with an equivalent sphere diameter of greater than about 2 micrometers) to carbon particles with an equivalent sphere of less than about 2 micrometers of about 0/100, 5/95, 10/90, 15/85, 20/80, 25/75, 30/70, 35/65, 40/60, 45/55, 50/50, 55/45, 60/40, 65/35, 70/30, 75/25, 80/20, 85/15, 90/10, or 100/0. The methods and systems described herein may be configured to be tuned to generate a predetermined ratio of larger carbon particles to carbon particles with a volume equivalent sphere of less than about 2 micrometers. The equivalent sphere diameter may be measured by centrifugal particle sedimometry. Additional information can be found in the book “Principles of Colloid and Surface Chemistry” Hiemenz, Rajagopalan. Third Edition. Pp. 70-78, which is incorporated by reference herein in its entirety.

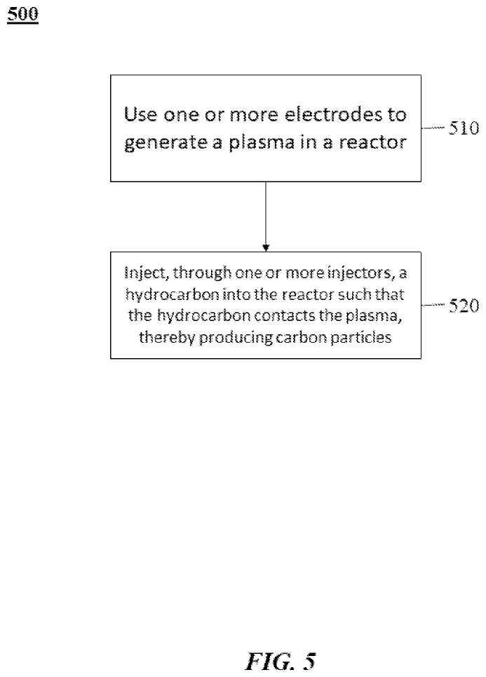

FIG. 5 shows a flow chart of a process 500 for making carbon particles in a reactor, according to some embodiments. In an operation 510, the process 500 may comprise using one or more electrodes to generate a plasma in the reactor. The carbon particles may be as described elsewhere herein.

In some cases, the one or more electrodes may comprise one or more alternating current (AC) electrodes. AC electrodes may be electrodes configured to operate under AC conditions. For example, AC electrodes can be electronically coupled to an AC power supply and generate a plasma when AC current is flowed through the AC electrodes. In some cases, the one or more electrodes may comprise one or more direct current (DC) electrodes. DC electrodes may be configured to operate under DC conditions (e.g., when operatively coupled to a DC power supply).

In another operation 520, the process 500 may comprise injecting, through one or more injectors, a hydrocarbon into the reactor such that the hydrocarbon contacts the plasma, thereby producing the carbon particles. The reactor may be operated at a pressure greater than or equal to at least about 0 bar, 0.5 bar, 1 bar, 1.1 bar, 1.2 bar, 1.3 bar, 1.4 bar, 1.5 bar, 1.6 bar, 1.7 bar, 1.8 bar, 1.9 bar, 2 bar, 2.1 bar, 2.2 bar, 2.3 bar, 2.4 bar, 2.5 bar, 2.6 bar, 2.7 bar, 2.8 bar, 2.9 bar, 3 bar, 3.1 bar, 3.2 bar, 3.3 bar, 3.4 bar, 3.5 bar, 3.6 bar, 3.7 bar, 3.8 bar, 3.9 bar, 4 bar, 4.5 bar, 5 bar, 6 bar, 7 bar, 8 bar, 9 bar, 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 35 bar, 40 bar, 45 bar, 50 bar, 55 bar, 60 bar, 65 bar, 70 bar, 75 bar, or more. The reactor may be operated at a pressure less than or equal to at most about 100 bar, 90 bar, 80 bar, 75 bar, 70 bar, 65 bar, 60 bar, 55 bar, 50 bar, 45 bar, 40 bar, 35 bar, 30 bar, 29 bar, 28 bar, 27 bar, 26 bar, 25 bar, 24 bar, 23 bar, 22 bar, 21 bar, 20 bar, 19 bar, 18 bar, 17 bar, 16 bar, 15 bar, 14 bar, 13 bar, 12 bar, 11 bar, 10 bar, 9 bar, 8 bar, 7 bar, 6 bar, 5 bar, 4 bar, 3.9 bar, 3.8 bar, 3.7 bar, 3.6 bar, 3.5 bar, 3.4 bar, 3.3 bar, 3.2 bar, 3.1 bar, 3 bar, 2.9 bar, 2.8 bar, 2.7 bar, 2.6 bar, 2.5 bar, 2.4 bar, 2.3 bar, 2.2 bar, 2.1 bar, 2 bar, 1.9 bar, 1.8 bar, 1.7 bar, 1.6 bar, 1.5 bar, 1.4 bar, 1.3 bar, 1.2 bar, 1.1 bar, or less. The reactor may be operated at a pressure in a range as defined by any two of the proceeding values. For example, the reactor may be operated at a pressure within a range of about 1.1 bar to about 4 bar.

In some cases, the process 500 may produce hydrogen. For example, in the production of the carbon particles, hydrogen gas can be produced as well. The hydrogen can be discarded (e.g., disposed of as waste from the process). The hydrogen can be collected (e.g., as an additional product of the process). The hydrogen and the carbon particles can be produced in a once-through, single stage process. For example, the hydrogen and the carbon particles can be produced at a same time (e.g., the process operations that generate the carbon particles can also generate the hydrogen). In this example, the hydrogen and the carbon particles can be produced in a single operation of the reactor (e.g., in a same hydrocarbon decomposition operation). The single stage process may provide increased reaction efficiency (e.g., the efficiency of heat transfer from the plasma to the feedstock). Further, the single stage process can provide for higher plasma temperatures. For example, the plasma in a single stage process can be at temperatures of about 3500 to about 4000 degrees Celsius. The single stage process may have a heat gradient between the center of the reactor and the walls of the reactor. The heat gradient between the center of the reactor and the walls of the reactor may be less in a single stage process than in a multi stage process. For example, a heat gradient in a single stage process can be from a central temperature of 3500 degrees Celsius to a wall temperature of about 1800 degrees Celsius, while a two stage process can have a central temperature of about 3500 degrees Celsius and a wall temperature of about 2200 to 2400 degrees Celsius. The single stage process may enable cost savings due to the types of materials of construction and maintenance possible. For example, the lower temperatures near the walls of the reactor may enable lower cost materials to be used for the construction of the reactor, and can reduce the thermal wear on the wall of the reactor. The single stage reactor may have a dense (e.g., optically dense) field of carbon particles at in or in close vicinity (e.g., as described elsewhere herein) of the plasma arc. Such a dense field can provide increased heat transfer into the carbon particles and decreased heat transfer to the walls of the reactor.

In some cases, the hydrogen and the carbon particles can be produced in a multi stage (e.g., two stage, three stage, etc.) process. For example, a two stage process can comprise a first injection of the hydrocarbon and a second injection of the hydrocarbon. The use of a multi stage process can reduce fouling in the reactor or on the electrodes by lowering the amount of hydrocarbon in a given area of the reactor. Multiple stages can also enable additional process operations to occur between the stages. For example, a water injection can be performed to remove fouling from the reactor without having to shut down the reactor or disable the plasma. Multiple stages can also provide increased mixing of the feedstocks into the plasma gas due to the increased velocity and momentum of the plasma gas.

The plasma reactors of the present disclosure may be operated at a temperature of at least about 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, or more degrees Celsius. The plasma reactors of the present disclosure may be operated at a temperature of at most about 4500, 4400, 4300, 4200, 4100, 4000, 3900, 3800, 3700, 3600, 3500, 3400, 3300, 3200, 3100, 3000, 2900, 2800, 2700, 2600, 2500, 2400, 2300, 2200, 2100, 2000, 1900, 1800, 1700, 1600, 1500, 1400, 1300, 1200, 1100, 1000, or less degrees Celsius. The plasma reactors of the present disclosure may be operated at a temperature in a range as defined by any two of the proceeding values. For example, a plasma reactor can be operated at a temperature from about 3500 to about 4000 degrees Celsius. The temperature gradient between the center of a reactor of the present disclosure and a wall of the reactor may be a difference of at least about 50, 100, 200, 300, 400, 500, 600, 700, 800, 900, 1000, 1100, 1200, 1300, 1400, 1500, 1600, 1700, 1800, 1900, 2000, or more degrees Celsius. For example, the difference in temperature between the center of the reactor and the wall of the rector can be at least about 1700 degrees Celsius. The temperature gradient between the center of a reactor of the present disclosure and a wall of the reactor may be a difference of at most about 2000, 1900, 1800, 1700, 1600, 1500, 1400, 1300, 1200, 1100, 1000, 900, 800, 700, 600, 500, 400, 300, 200, 100, 50, or fewer degrees Celsius. The temperature gradient between the center of a reactor of the present disclosure and the wall of the reactor may be defined by a range of any two of the proceeding values. The magnitude of the gradient may be related to the type of reactor system used. For example, a single stage reactor can provide a larger temperature gradient than a multi stage reactor.

In some cases, the systems and methods described herein produce 1 ton per hour of hydrogen. The produced hydrogen may be purified to a given purity of, for example, 90%, 95%, 99%, 99.5%, or 99.9%. In some cases, hydrogen is produced at a rate of about 0.1 tons per hour to about 10 tons per hour. In some cases, hydrogen is produced at a rate of about 0.1 tons per hour to about 0.5 tons per hour, about 0.1 tons per hour to about 1 ton per hour, about 0.1 tons per hour to about 5 tons per hour, about 0.1 tons per hour to about 10 tons per hour, about 0.5 tons per hour to about 1 ton per hour, about 0).5 tons per hour to about 5 tons per hour, about 0.5 tons per hour to about 10 tons per hour, about 1 ton per hour to about 5 tons per hour, about 1 ton per hour to about 10 tons per hour, or about 5 tons per hour to about 10 tons per hour. In some cases, hydrogen is produced at a rate of about 0.1 tons per hour, about 0.5 tons per hour, about 1 ton per hour, about 5 tons per hour, or about 10 tons per hour. In some cases, hydrogen is produced at a rate of at least about 0.1 tons per hour, about 0.5 tons per hour, about 1 ton per hour, or about 5 tons per hour. In some cases, hydrogen is produced at a rate of at most about 0.5 tons per hour, about 1 ton per hour, about 5 tons per hour, or about 10 tons per hour.

The hydrocarbon may be as described elsewhere herein. For example, the hydrocarbon may be a gas (e.g., comprise natural gas). The hydrocarbon can be heated upon contact with the plasma. For example, the interaction of the hydrocarbon and the plasma can result in energy being imparted into the hydrocarbon from the plasma, thereby heating the hydrocarbon. The hydrocarbon can be cracked (e.g., at least partially decomposed) upon contact with the plasma.

The carbon particles may have a smaller surface area than carbon particles formed in a reactor operated at a lower pressure than the reactor of process 500. For example, if the reactor of process 500 is operated at a pressure of 1.5 bar, the carbon particles generated by the reactor operated at a pressure of 1.5 bar may have a smaller surface area than carbon particles formed in the same reactor operated at a pressure of 2.5 bar. In another example, if the reactor of process 500 is operated at a pressure of 5 bar, the carbon particles generated by the reactor operated at a pressure of 5 bar may have a smaller surface area than carbon particles formed in the same reactor operated at a pressure of 3 bar. The carbon particles may have a surface area of at least about 5, 10, 15, 20, 25, 30, 35, 40, 45, 50, 55, 60, 65, 70, 75, 80, 81, 82, 83, 84, 85, 86, 87, 88, 89, 90, 91, 92, 93, 94, 95, 96, 97, 98, 99, 99.9, or more percent of the surface area of carbon particles formed in the reactor if the reactor is operated at a pressure lower than the pressure of the reactor of process 500 (e.g., lower than about 1.5 bar, lower than about 5 bar, lower than about 10 bar, etc.). The carbon particles may have a surface area of at most about 99.9, 99, 98, 97, 96, 95, 94, 93, 92, 91, 90, 89, 88, 87, 86, 85, 84, 83, 82, 81, 80, 75, 70, 65, 60, 55, 50, 45, 40, 35, 30, 25, 20, 15, 10, 5, or less percent of the surface area of carbon particles formed in the reactor if the reactor is operated at a pressure lower than the pressure of the reactor of process 500 (e.g., lower than about 1.5 bar, lower than about 5 bar, lower than about 10 bar, etc.).

The surface area of the carbon particles may be increased using one or more additives. The one or more additives may be added to the hydrocarbon before, during, or after the hydrocarbon is injected into the reactor. The one or more additives may be injected into the reactor prior to the plasma. Examples of additives include, but are not limited to, hydrocarbons (e.g., hydrocarbons a described elsewhere herein, hydrocarbon gasses), silicon-containing compounds (e.g., siloxanes, silanes, etc.), aromatic additives (e.g., benzene, xylenes, polycyclic aromatic hydrocarbons, etc.), or the like, or any combination thereof. The reactor may be an oxygen-free environment. The oxygen-free environment may be an unbound oxygen-free environment. For example, the reactor may be substantially free of unbound oxygen (e.g., elemental oxygen) but may comprise bound oxygen (e.g., as a part of ethanol, carbon dioxide, etc.). The reactor may comprise less than at most about 20, 15, 14, 13, 12, 11, 10, 9, 8, 7, 6, 5, 4, 3, 2, 1, 0.5, 0.1, 0.05, 0.01, 0.005, 0.001, 0.0005, 0.0001, or less percent molecular oxygen by volume or mole.

The carbon particles may comprise carbon black. Examples of carbon particles include, but are not limited to, carbon black, coke, needle coke, graphite, large ring polycyclic aromatic hydrocarbons, activated carbon, or the like, or any combination thereof. The carbon particles may be produced by the process 500 at a yield greater than a yield of carbon particles formed by the reactor when operated at a lower pressure than the pressure of the process 500 (e.g., about 1 bar, less than about 1.5 bar, etc.). The carbon particles may be produced at a yield of at least about 5, 10, 15, 20, 25, 30, 35, 40, 45, 50, 55, 60, 65, 70, 75, 80, 81, 82, 83, 84, 85, 86, 87, 88, 89, 90, 91, 92, 93, 94, 95, 96, 97, 98, 99, 99.9, or more percent. The carbon particles may be produced at a yield of at most about 99.9, 99, 98, 97, 96, 95, 94, 93, 92, 91, 90, 89, 88, 87, 86, 85, 84, 83, 82, 81, 80, 75, 70, 65, 60, 55, 50, 45, 40, 35, 30, 25, 20, 15, 10, 5, or less percent. The yield of the carbon particles may be a value in a range as defined by any two of the proceeding values. For example, the yield of the carbon particles may be from about 90 to about 99 percent. The yield of the carbon particles in the process 500 may be greater than a yield of carbon particles formed in a different reactor of a same size as the reactor of the process 500 when the different reactor is operated at a pressure less than that of the reactor of process 500.

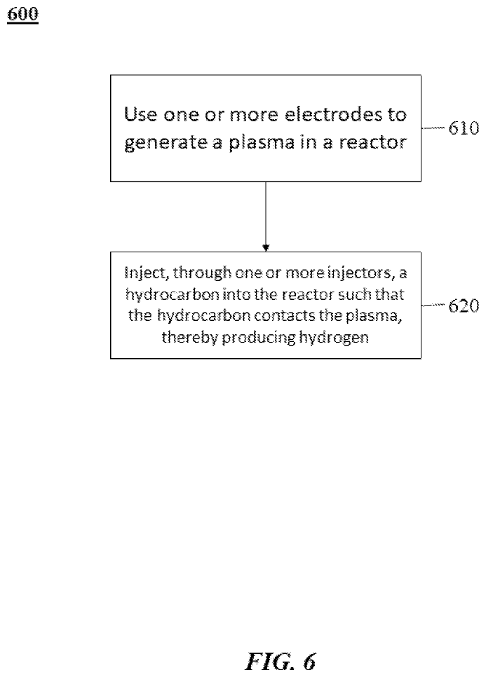

FIG. 6 shows a flowchart of a process 600 for producing hydrogen in a reactor, according to some embodiments. In an operation 610, the process 600 may comprise using one or more electrodes to generate a plasma in the reactor. In some cases, the one or more electrodes may comprise one or more alternating current (AC) electrodes. AC electrodes may be electrodes configured to operate under AC conditions. For example, AC electrodes can be electronically coupled to an AC power supply and generate a plasma when AC current is flowed through the AC electrodes. In some cases, the one or more electrodes may comprise one or more direct current (DC) electrodes. DC electrodes may be configured to operate under DC conditions (e.g., when operatively coupled to a DC power supply).

In some cases, the systems and methods described herein produce 1 ton per hour of hydrogen. The produced hydrogen may be purified to a given purity of, for example, 90%, 95%, 99%, 99.5%, or 99.9%. In some cases, hydrogen is produced at a rate of about 0.1 tons per hour to about 10 tons per hour. In some cases, hydrogen is produced at a rate of about 0.1 tons per hour to about 0.5 tons per hour, about 0.1 tons per hour to about 1 ton per hour, about 0.1 tons per hour to about 5 tons per hour, about 0.1 tons per hour to about 10 tons per hour, about 0.5 tons per hour to about 1 ton per hour, about 0.5 tons per hour to about 5 tons per hour, about 0.5 tons per hour to about 10 tons per hour, about 1 ton per hour to about 5 tons per hour, about 1 ton per hour to about 10 tons per hour, or about 5 tons per hour to about 10 tons per hour. In some cases, hydrogen is produced at a rate of about 0.1 tons per hour, about 0.5 tons per hour, about 1 ton per hour, about 5 tons per hour, or about 10 tons per hour. In some cases, hydrogen is produced at a rate of at least about 0.1 tons per hour, about 0.5 tons per hour, about 1 ton per hour, or about 5 tons per hour. In some cases, hydrogen is produced at a rate of at most about 0.5 tons per hour, about 1 ton per hour, about 5 tons per hour, or about 10 tons per hour.

In another operation 620, the process 600 may comprise injecting, through one or more injectors, a hydrocarbon into the reactor such that the hydrocarbon contacts the plasma. thereby producing the hydrogen. The reactor may be operated at a pressure greater than or equal to at least about 0 bar, 0.5 bar, 1 bar, 1.1 bar, 1.2 bar, 1.3 bar, 1.4 bar, 1.5 bar, 1.6 bar, 1.7 bar, 1.8 bar, 1.9 bar, 2 bar, 2.1 bar, 2.2 bar, 2.3 bar, 2.4 bar, 2.5 bar, 2.6 bar, 2.7 bar, 2.8 bar, 2.9 bar, 3 bar, 3.1 bar, 3.2 bar, 3.3 bar, 3.4 bar, 3.5 bar, 3.6 bar, 3.7 bar, 3.8 bar, 3.9 bar, 4 bar, 4.5 bar, 5 bar, 6 bar, 7 bar, 8 bar, 9 bar, 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 35 bar, 40 bar, 45 bar, 50 bar, 55 bar, 60 bar, 65 bar, 70 bar, 75 bar, or more. The reactor may be operated at a pressure less than or equal to at most about 100 bar, 90 bar, 80 bar, 75 bar, 70 bar, 65 bar, 60 bar, 55 bar, 50 bar, 45 bar, 40 bar, 35 bar, 30 bar, 29 bar, 28 bar, 27 bar, 26 bar, 25 bar, 24 bar, 23 bar, 22 bar, 21 bar, 20 bar, 19 bar, 18 bar, 17 bar, 16 bar, 15 bar, 14 bar, 13 bar, 12 bar, 11 bar, 10 bar, 9 bar, 8 bar, 7 bar, 6 bar, 5 bar, 4 bar, 3.9 bar, 3.8 bar, 3.7 bar, 3.6 bar, 3.5 bar, 3.4 bar, 3.3 bar, 3.2 bar, 3.1 bar, 3 bar, 2.9 bar, 2.8 bar, 2.7 bar, 2.6 bar, 2.5 bar, 2.4 bar, 2.3 bar, 2.2 bar, 2.1 bar, 2 bar, 1.9 bar, 1.8 bar, 1.7 bar, 1.6 bar, 1.5 bar, 1.4 bar, 1.3 bar, 1.2 bar, 1.1 bar, or less. The reactor may be operated at a pressure in a range as defined by any two of the proceeding values. For example, the reactor may be operated at a pressure within a range of about 1.1 bar to about 4 bar.

In some cases, the process 600 further comprises producing carbon particles. The carbon particles may be as described elsewhere herein. For example, in the process of generating the hydrogen, carbon particles can be produced at the same time. The process may comprise continuously producing the hydrogen and the carbon particles. For example, the hydrogen and the carbon particles can be produced without breaks (e.g., not in a batch process). The hydrogen and the carbon particles may be generated in a once-through, single stage process as described elsewhere herein.

In some cases, the hydrocarbon is as described elsewhere herein. For example, the hydrocarbon can comprise natural gas. The hydrocarbon may be heated upon contact with the plasma as described elsewhere herein. In some cases, the reactor is an oxygen-free environment as described elsewhere herein. For example, the reactor can comprise less than about 2% molecular oxygen by volume or mole.

FIG. 10 is an example of a high pressure degassing apparatus 1000, according to some embodiments. Carbon particles as described elsewhere herein (e.g., carbon black, etc.) generated by the processes described elsewhere herein can be directed into the top of the degassing apparatus as indicated. The carbon particles can initially contact a filter prior to the high pressure degassing apparatus, and fall from the filter into the top of the apparatus as shown. The carbon particles can contact the rotary valve 1001. The rotary valve can be configured to meter the carbon particles by dropping the carbon particles through open airlock valves 1002 into the degassing vessel 1003. The presence of the rotary valve may prevent too many carbon particles from entering the degassing vessel at once. The rotary valve may also provide an amount of backflow protection against gasses from the degassing vessel flowing back. The carbon particles can collect in the degassing vessel until a predetermined amount of carbon particles has been reached. Subsequently, the rotary valve 1001 and the airlock valves 1002 can be closed, and the vent valve 1005 can be opened. The vent valve opening can relieve the gas at pressure in the degassing vessel (e.g., if the carbon particles are introduced to the vessel under pressure) and place the degassing vessel at atmospheric pressures. The vent valve can then be closed, and an inert purge valve 1004 can be opened to permit flow of inert gasses (e.g., inert gasses as described elsewhere herein). The inert gasses may be configured to displace and/or dilute gasses associated (e.g., adsorbed) with the carbon particles. For example, combustible and/or explosive gasses (e.g., hydrogen, hydrocarbons, etc.) can be adsorbed to the surface of the carbon particles, and the inert gasses can displace the combustible and/or explosive gasses. Subsequent to the introduction of the inert gasses, the purge valve 1004 can be closed, and the vent valve 1005 can be opened to vent the mixture of the inert gas and the gasses associated with the carbon particles. The purging with inert gasses can be repeated until the carbon particles are considered inert (e.g., the gasses within the carbon particles are present at a safe level). The carbon particles can then be removed from the degassing vessel via airlock valves 1006. For example, the airlock valves can be opened and the carbon particles can fall out of the degassing vessel via gravity. The airlock valves 1006 can then be closed and the process repeated for another batch of carbon particles.

Use of a high pressure degassing apparatus may enable collection of gasses associated with the carbon particles (e.g., hydrogen) at elevated pressures. For example, the hydrogen adsorbed to the pores of the carbon particles can be collected at the same elevated pressure as the reactor system is operated at. Recovering the gasses at elevated pressures can enable use of the gasses in elevated pressure systems (e.g., high pressure chemical synthesis, combustion, fuel cells, etc.) without the use of a secondary pressurizing apparatus. Thus, the gasses can be more easily used in downstream processes due to the elevated pressure of the gasses. This can reduce engineering requirements and improve the functioning of systems as compared to if the gasses were at lower pressures.

In a non-limiting example, a reactor according to the present disclosure can be provided with an energy input of 19 megawatts and a flow of 5.7 tons/hour of natural gas feedstock. In this example, a 10 kilogram/hour purge of inert gas (e.g., argon) can be provided with a 50 kilogram/hour recycle gas stream (e.g., comprising 40% H₂, 10% natural gas, 10% ethylene, 10% ethane, 10% other hydrocarbons, trace HCN, 20% Ar, 10% CO, or any combination of percentages thereof). In this example, about 1.25 tons of hydrogen can be produced per hour, with about 3.5 tons per hour of carbon particles. In this example, an electrode wear rate of about 8 kilograms per ton of carbon particles can be observed.

In another non-limiting example, a two stage atmospheric reactor can be contrasted with the increased pressure reactors of the present disclosure. The atmospheric reactor may be supplied with 18 megawatts of energy, 3 tons/hour of natural gas feedstock, and 300 kilograms of recycle hydrogen. In this example, only 75 tons/hour of hydrogen may be produced with 2 tons/hour of carbon particles at a similar 8 kilogram/ton of carbon particle electrode wear. As show by this example, the increased pressures of the present disclosure can provide savings on capital costs and improved efficiencies as compared to the two stage atmospheric reactor.

Systems and methods of the present disclosure may be combined with or modified by other systems and/or methods (with appropriate modification(s)), such as chemical processing and heating methods, chemical processing systems, reactors and plasma torches described in U.S. Pat. Pub. No. US 2015/0210856 and Int. Pat. Pub. No. WO 2015/116807 (“SYSTEM FOR HIGH TEMPERATURE CHEMICAL PROCESSING”), U.S. Pat. Pub. No. US 2015/0211378 (“INTEGRATION OF PLASMA AND HYDROGEN PROCESS WITH COMBINED CYCLE POWER PLANT, SIMPLE CYCLE POWER PLANT AND STEAM REFORMERS”), Int. Pat. Pub. No. WO 2015/116797 (“INTEGRATION OF PLASMA AND HYDROGEN PROCESS WITH COMBINED CYCLE POWER PLANT AND STEAM REFORMERS”), U.S. Pat. Pub. No. US 2015/0210857 and Int. Pat. Pub. No. WO 2015/116798 (“USE OF FEEDSTOCK IN CARBON BLACK PLASMA PROCESS”), U.S. Pat. Pub. No. US 2015/0210858 and Int. Pat. Pub. No. WO 2015/116800 (“PLASMA GAS THROAT ASSEMBLY AND METHOD”), U.S. Pat. Pub. No. US 2015/0218383 and Int. Pat. Pub. No. WO 2015/116811 (“PLASMA REACTOR”), U.S. Pat. Pub. No. US2015/0223314 and Int. Pat. Pub. No. WO 2015/116943 (“PLASMA TORCH DESIGN”), Int. Pat. Pub. No. WO 2016/126598 (“CARBON BLACK COMBUSTABLE GAS SEPARATION”), Int. Pat. Pub. No. WO 2016/126599 (“CARBON BLACK GENERATING SYSTEM”), Int. Pat. Pub. No. WO 2016/126600 (“REGENERATIVE COOLING METHOD AND APPARATUS”), U.S. Pat. Pub. No. US 2017/0034898 and Int. Pat. Pub. No. WO 2017/019683 (“DC PLASMA TORCH ELECTRICAL POWER DESIGN METHOD AND APPARATUS”), U.S. Pat. Pub. No. US 2017/0037253 and Int. Pat. Pub. No. WO 2017/027385 (“METHOD OF MAKING CARBON BLACK”), U.S. Pat. Pub. No. US 2017/0058128 and Int. Pat. Pub. No. WO 2017/034980 (“HIGH TEMPERATURE HEAT INTEGRATION METHOD OF MAKING CARBON BLACK”), U.S. Pat. Pub. No. US 2017/0066923 and Int. Pat. Pub. No. WO 2017/044594 (“CIRCULAR FEW LAYER GRAPHENE”), U.S. Pat. Pub. No. US20170073522 and Int. Pat. Pub. No. WO 2017/048621 (“CARBON BLACK FROM NATURAL GAS”), Int. Pat. Pub. No. WO 2017/190045 (“SECONDARY HEAT ADDITION TO PARTICLE PRODUCTION PROCESS AND APPARATUS”), Int. Pat. Pub. No. WO 2017/190015 (“TORCH STINGER METHOD AND APPARATUS”), Int. Pat. Pub. No. WO 2018/165483 (“SYSTEMS AND METHODS OF MAKING CARBON PARTICLES WITH THERMAL TRANSFER GAS”), Int. Pat. Pub. No. WO 2018/195460 (“PARTICLE SYSTEMS AND METHODS”), Int. Pat. Pub. No. WO 2019/046322 (“PARTICLE SYSTEMS AND METHODS”), Int. Pat. Pub. No. WO 2019/046320 (“SYSTEMS AND METHODS FOR PARTICLE GENERATION”), Int. Pat. Pub. No. WO 2019/046324 (“PARTICLE SYSTEMS AND METHODS”), Int. Pat. Pub. No. WO 2019/084200 (“PARTICLE SYSTEMS AND METHODS”), and Int. Pat. Pub. No. WO 2019/195461 (“SYSTEMS AND METHODS FOR PROCESSING”), each of which is entirely incorporated herein by reference.

### Computer Systems

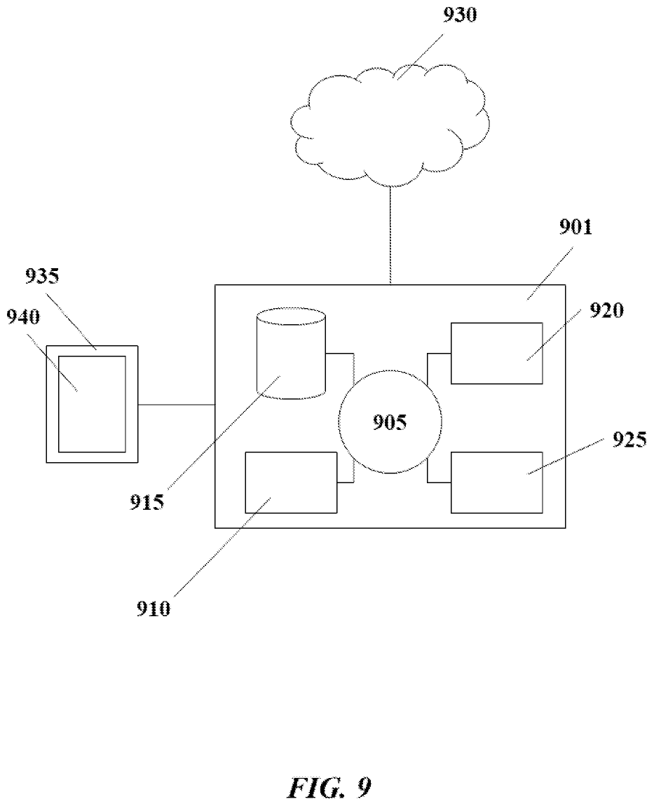

The present disclosure provides computer systems that are programmed to implement methods of the disclosure. FIG. 9 shows a computer system 901 that is programmed or otherwise configured to implement the methods of the present disclosure, e.g., method for forming carbon particles and/or hydrogen. The computer system 901 can regulate various aspects of the present disclosure, such as, for example, the operation of a reactor. The computer system 901 can be an electronic device of a user or a computer system that is remotely located with respect to the electronic device. The electronic device can be a mobile electronic device.

The computer system 901 includes a central processing unit (CPU, also “processor” and “computer processor” herein) 905, which can be a single core or multi core processor, or a plurality of processors for parallel processing. The computer system 901 also includes memory or memory location 910 (e.g., random-access memory, read-only memory, flash memory), electronic storage unit 915 (e.g., hard disk), communication interface 920) (e.g., network adapter) for communicating with one or more other systems, and peripheral devices 925, such as cache, other memory, data storage and/or electronic display adapters. The memory 910, storage unit 915, interface 920 and peripheral devices 925 are in communication with the CPU 905 through a communication bus (solid lines), such as a motherboard. The storage unit 915 can be a data storage unit (or data repository) for storing data. The computer system 901 can be operatively coupled to a computer network (“network”) 930 with the aid of the communication interface 920. The network 930 can be the Internet, an internet and/or extranet, or an intranet and/or extranet that is in communication with the Internet. The network 930 in some cases is a telecommunication and/or data network. The network 930 can include one or more computer servers, which can enable distributed computing, such as cloud computing. The network 930, in some cases with the aid of the computer system 901, can implement a peer-to-peer network, which may enable devices coupled to the computer system 901 to behave as a client or a server.

The CPU 905 can execute a sequence of machine-readable instructions, which can be embodied in a program or software. The instructions may be stored in a memory location, such as the memory 910. The instructions can be directed to the CPU 905, which can subsequently program or otherwise configure the CPU 905 to implement methods of the present disclosure. Examples of operations performed by the CPU 905 can include fetch, decode, execute, and writeback.

The CPU 905 can be part of a circuit, such as an integrated circuit. One or more other components of the system 901 can be included in the circuit. In some cases, the circuit is an application specific integrated circuit (ASIC).

The storage unit 915 can store files, such as drivers, libraries and saved programs. The storage unit 915 can store user data, e.g., user preferences and user programs. The computer system 901 in some cases can include one or more additional data storage units that are external to the computer system 901, such as located on a remote server that is in communication with the computer system 901 through an intranet or the Internet.

The computer system 901 can communicate with one or more remote computer systems through the network 930. For instance, the computer system 901 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 901 via the network 930.

Methods as described herein can be implemented by way of machine (e.g., computer processor) executable code stored on an electronic storage location of the computer system 901, such as, for example, on the memory 910 or electronic storage unit 915. The machine executable or machine readable code can be provided in the form of software. During use, the code can be executed by the processor 905. In some cases, the code can be retrieved from the storage unit 915 and stored on the memory 910 for ready access by the processor 905. In some situations, the electronic storage unit 915 can be precluded, and machine-executable instructions are stored on memory 910.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers. processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 901 can include or be in communication with an electronic display 935 that comprises a user interface (UI) 940 for providing, for example, access to controls for operating a reactor. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 905. The algorithm can, for example, at least partially autonomously operate a reactor system.

### EXAMPLE EMBODIMENTS OF THE DISCLOSURE

1. A method of processing, comprising producing hydrogen by heating a hydrocarbon with a plasma generator at a pressure greater than atmospheric pressure.
2. The method of aspect 1, further comprising adding the hydrocarbon to the plasma generator.
3. The method of aspect 1, wherein the plasma generator comprises AC electrodes.
4. The method of aspect 1, wherein the plasma generator comprises DC electrodes.
5. The method of aspect 1, further comprising producing carbonaceous material.
6. The method of aspect 5, wherein the carbonaceous material comprises carbon particles.
7. The method of aspect 5, further comprising continuously producing the hydrogen and the carbonaceous material.
8. The method of aspect 1, wherein the hydrocarbon is a gas.
9. The method of aspect 1, wherein the hydrocarbon comprises natural gas.
10. The method of aspect 9, wherein the hydrocarbon is natural gas.
11. The method of aspect 5, further comprising heating the hydrocarbon and producing the hydrogen in a single chamber.
12. The method of aspect 5, further comprising producing the hydrogen and the carbonaceous material in a once-through, single stage process.
13. The method of aspect 5, wherein the pressure is greater than or equal to about 2 bar.
14. The method of aspect 18, wherein the pressure is greater than or equal to about 5 bar.
15. The method of aspect 19, wherein the pressure is greater than or equal to about 10 bar.
16. A method of processing, comprising producing hydrogen in a substantially inert or substantially oxygen-free environment or atmosphere by heating a hydrocarbon with electrical energy at a pressure greater than atmospheric pressure.
17. The method of aspect 16, further comprising producing carbonaceous material.
18. The method of aspect 17, wherein the carbonaceous material comprises carbon particles.
19. The method of aspect 17, further comprising continuously producing the hydrogen and the carbonaceous material.
20. The method of aspect 16, wherein the hydrocarbon is a gas.
21. The method of aspect 16, wherein the hydrocarbon comprises natural gas.
22. The method of aspect 21, wherein the hydrocarbon is natural gas.
23. The method of aspect 16, further comprising heating the hydrocarbon with a plasma generator.
24. The method of aspect 16, further comprising directly heating the hydrocarbon with electrical energy.
25. The method of aspect 16, further comprising producing the hydrogen in a refractory-lined reactor.
26. The method of aspect 16, further comprising heating the hydrocarbon and producing the hydrogen in a single chamber.
27. The method of aspect 16, further comprising producing the hydrogen and the carbonaceous material in a once-through, single stage process.
28. The method of aspect 16, further comprising using the electrical energy to remove the hydrogen from the hydrocarbon.
29. The method of aspect 16, wherein the pressure is greater than or equal to about 2 bar.
30. The method of aspect 29, wherein the pressure is greater than or equal to about 5 bar.
31. The method of aspect 30, wherein the pressure is greater than or equal to about 10 bar.
32. The method of aspect 16, further comprising using a heat exchanger, a filter and solid handling equipment.
33. The method of aspect 32, wherein the solid handling equipment includes a cooled solid carbon collection screw conveyor, an air locking and purge system, a pneumatic conveying system, a mechanical conveying system, a classifying mill, and a product storage vessel.
34. The method of aspect 16, further comprising producing the hydrogen in a substantially oxygen-free environment or atmosphere.
35. The method of aspect 16, further comprising producing the hydrogen in a substantially inert environment or atmosphere.
36. A method of processing, comprising producing hydrogen in a substantially inert or substantially oxygen-free environment or atmosphere by directly heating a hydrocarbon with electrical energy.
37. The method of aspect 36, wherein the hydrocarbon is a gas.
38. The method of aspect 36, wherein the hydrocarbon comprises natural gas.
39. The method of aspect 38, wherein the hydrocarbon is natural gas.
40. The method of aspect 36, further comprising producing carbonaceous material.
41. The method of aspect 40, wherein the carbonaceous material comprises carbon particles.
42. The method of aspect 40, further comprising continuously producing the hydrogen and the carbonaceous material.
43. The method of aspect 36, further comprising generating a plasma.
44. The method of aspect 43, further comprising generating the plasma using AC electrodes.
45. The method of aspect 43, further comprising generating the plasma using DC electrodes.
46. The method of aspect 36, further comprising producing the hydrogen in an environment or atmosphere comprising less than about 2% molecular oxygen by volume or mole.
47. The method of aspect 36, further comprising directly heating the hydrocarbon and producing the hydrogen in a single chamber.
48. The method of aspect 36, further comprising producing the hydrogen and the carbonaceous material in a once-through, single stage process.
49. A device, comprising: a reactor configured to operate at about 10 megawatts of input power to generate a thermal plasma in a confined space, wherein the reactor operates at a pressure of at least about 1.5 bar, wherein the temperature of the wall of the reactor is less than about 2000 degrees Celsius, and wherein the distance from the center of the reactor to the walls of the reactor is less than about 3 meters.
50. The device of aspect 49, wherein, during use, the reactor comprises a temperature gradient between a center of the reactor and the wall of the reactor.
51. The device of aspect 50, wherein the gradient is formed at least in part due to a hydrocarbon being used as at least a portion of a plasma gas within the reactor.
52. The device of aspect 51, wherein the gradient of the reactor is at least about 10% larger than a reactor that does not have the hydrocarbon being used as at least a portion of the plasma gas.

The following examples are illustrative of certain systems and methods described herein and are not intended to be limiting

### EXAMPLE 1—PREDICTED PROPERTIES OF ABOVE AMBIENT PRESSURE REACTORS

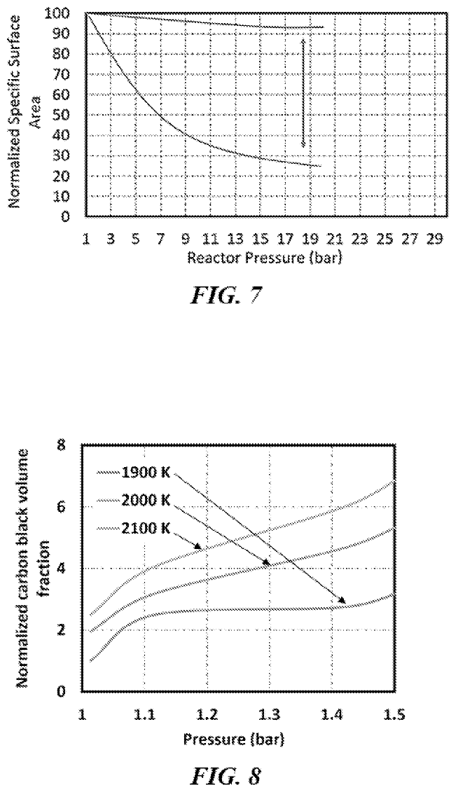

FIG. 7 is a plot of an example of a range of reactor pressures versus normalized surface area measurements, according to an embodiment. The conditions used in the generation of this example may be the use of a plug flow reactor at 1900 K with methane, hydrogen, and nitrogen as process gasses.

The plot indicates that as the reactor pressure increases, the expected surface area of carbon particles made in that reactor decreases. The extent of the surface area decrease may be related to, among other properties, reactor configuration, reactant concentration, surrounding gas environment composition, feedstock composition, imposed fluid-thermal environment, or the like, or any combination thereof.

FIG. 8 is a plot of an example demonstration of the increase in reactor yield with increasing reactor pressure, according to an embodiment. The plot may show a simulation generated using the CNATERA software framework.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-89. (canceled)

90. A method of producing carbon particles in a reactor, comprising:
(a) using electrodes to generate a plasma in the reactor; and
(b) injecting, through one or more injectors, a hydrocarbon into the reactor, thereby producing the carbon particles,
wherein the reactor is operated at a pressure greater than or equal to about 1.5 bar, and wherein greater than 30% of the carbon particles have an equivalent sphere diameter of less than about 2 micrometers.

91. The method of claim 90, wherein the electrodes comprise AC electrodes.

92. The method of claim 90, wherein the electrodes comprise DC electrodes.

93. The method of claim 90, further comprising producing hydrogen.

94. The method of claim 93, wherein the hydrogen and the carbon particles are produced in a once-through, single stage process.

95. The method of claim 90, wherein the hydrocarbon is a gas that is heated upon contact with the plasma.

96. The method of claim 90, wherein the carbon particles have a surface area about 10% smaller than a reference surface area of reference carbon particles formed in a comparable reactor when such comparable reactor is operated at a pressure of about 1 bar.

97. The method of claim 90, wherein the reactor is operated at a pressure greater than or equal to about 5 bar.

98. The method of claim 90, wherein the reactor is operated at a pressure greater than or equal to about 5 bar, and wherein the carbon particles have a surface area about 40% smaller than a reference surface area of reference carbon particles formed in a comparable reactor when such comparable reactor is operated at a pressure of about 1 bar.

99. The method of claim 90, wherein the reactor is operated at a pressure greater than or equal to about 10 bar.

100. The method of claim 90, wherein the reactor is operated at a pressure greater than or equal to about 10 bar, and wherein the carbon particles have a surface area about 65% smaller than a reference surface area of reference carbon particles formed in a comparable reactor when such comparable reactor is operated at a pressure of about 1 bar.

101. The method of claim 90, further comprising including an additive with the hydrocarbon to increase the surface area of the carbon particles.

102. The method of claim 101, wherein the additive comprises a hydrocarbon gas, a silicon, or an aromatic additive.

103. The method of claim 90, wherein the reactor comprises an oxygen-free environment of less than about 2% molecular oxygen by volume or mole.

104. The method of claim 93, further comprising using a pressure lock system to isolate the carbon particles, remove at least a portion of hydrogen produced, and depressurize the atmosphere surrounding the carbon particles to less than 1.5 bar.

105. The method of claim 90, wherein each of the one or more electrodes has a mass of greater than 10 kg.

106. The method of claim 90, wherein the carbon particles are produced at a rate greater than 2 tons/hour.

107. The method of claim 93, wherein the hydrogen is produced at a rate greater than 0.75 ton/hour.

108. The method of claim 90, further comprising flowing a sheath gas to the reactor.

109. The method of claim 90, wherein the hydrocarbon is used as a plasma gas to generate the plasma.
